(19) United States
(12) Patent Application Publication
(10) Pub. No.: US 2024/0052942 A1
(43) Pub. Date: Feb. 15, 2024

(54) FIELD-DEVICE COUPLING WITH TWO COUPLING ORIENTATIONS

(71) Applicant: BELIMO HOLDING AG, Hinwil (CH)

(72) Inventors: Andrew JUKES, Adliswil (CH); Urs NIEDERHAUSER, Pfungen (CH); Georg BAMBERGER, Winterthur (CH); Urs KELLER, Hinwil (CH)

(73) Assignee: BELIMO HOLDING AG, Hinwil (CH)

(21) Appl. No.: 18/493,982

(22) Filed: Oct. 25, 2023

Related U.S. Application Data
(63) Continuation-in-part of application No. PCT/EP2022/059709, filed on Apr. 12, 2022.

(30) Foreign Application Priority Data
Apr. 26, 2021 (CH) 00447/21

(51) Int. Cl. F16K 31/04

(52) U.S. Cl. CPC F16K 31/043; F16K 31/042

(57) ABSTRACT

An anti-rotation connector for releasable coupling a field device with an inner room of a fluidic component via an anti-rotation counter-connector includes a connector stub, an access channel, and a first connector-sided anti-rotation structure. The connector stub has a stub body that extends along a connector axis. The access channel is coaxial with respect to the connector axis and extends through the stub body. The first connector-sided anti-rotation structure is arranged at a lateral stub body surface and is rotationally symmetric of order two with respect to the connector axis. The first connector-sided anti-rotation structure is engageable with a first counter-connector-sided anti-rotation structure of the anti-rotation counter-connector by relatively displacing the connector and the counter-connector towards each other. A locking connector for the releasable coupling includes the connector stub, the access channel, and a circumferential locking structure that is arranged at a lateral stub body surface.

### FIELD OF THE INVENTION

The present invention relates to the releasable coupling of field devices, in particular actuators and/or sensors to the inner room of a fluidic component. The invention is particularly useful for example in the field of heating, ventilation and air conditioning (HVAC) systems as well as fire control systems.

### BACKGROUND OF THE INVENTION

In many cases for example in the framework of HVAC systems, field devices need to be operationally coupled with the fluid-fluid-carrying inner room of a fluidic component. Typical fluidic components may be control valves, flap or damper arrangements or general fluidic tubing. Often, such fluidic components include a rotatable member, such as the regulation body of a control valve or a damper of a damper arrangement that needs to be controlled respectively moved via an actuator, for example an electric servo drive as field device. Further, sensors, such as temperature sensors, pressure sensors, ultrasonic flow sensors or air quality sensors, e. g. Particulate Patter (PM), CO2 concentration or Volatile Organic Compounds (VOC) sensors, are field devices that are commonly arranged in a fluidic component, for example a fluidic tubing. In all these cases, it is required to provide an access to the inner room of the fluidic component in a sealing manner.

Another typical application field are fire control systems which typically include, among others, a number of damper arrangements with fire protection dampers and/or smoke extractor dampers that need to be moved in an emergency case with high reliability and under adverse conditions.

For solving these tasks, a variety of interfaces and cooling elements have been developed for different applications. General problems that are associated with typical application scenarios and in typical known designs of such interfaces are related to the fact that the field devices typically need to be coupled with or decoupled from a fluidic component under constraint space conditions as well as limited access and/or sight. Therefore, it is desirable to allow a mounting of the field device in different orientations. However, in the case of for example an electric servo drive that is coupled with a movable member, the electric servo drive and the servo drive generally need to be orientated with respect to each other in a defined manner and/or configuration respectively programming is required for correct operation, with the programming respectively configuration being time-consuming and susceptible to mistakes. Further, it is desirable to enable a coupling and decoupling in a quick, convenient and fail-safe respectively error-proof manner also under adverse conditions as mentioned before.

### SUMMARY OF THE INVENTION

It is an overall objective of the present invention to improve the start of the art regarding the coupling and decoupling of a field device with the inner room of a fluidic component, taking into account the before-mentioned problems and boundary conditions. Favorably, coupling and decoupling can be achieved without requiring additional tools as well as in a fail safe and convenient manner.

Field devices within the meaning of the present disclosure are in particular actuators, such as electric servo drives for moving a movable member arranged within a fluidic component, or sensors for measuring at least one characteristic of a fluid within the fluidic component, such as pressure, temperature or flow. The fluid may generally be gas, liquid, or a mixture thereof, such as air, smoke, steam, water, and/or glycol.

A fluidic component is generally to be understood as component that is configured to enclose and guide a fluid flow of a fluid in its inner room. Particular fluidic components are valves, such as control valves, and/or damper arrangements with a rotatable damper arranged in a fluid conduit, in particular gas conduit.

In a general manner, the overall objective is achieved by a connector for releasable coupling a field device with an inner room of a fluidic component via a counter-connector in accordance with the present disclosure and a counter-connector for releasable coupling a field device with an inner room of a fluidic component via a connector in accordance with the present disclosure. The connector may in particular be an anti-rotation connector and the counter-connector may be an anti-rotation counter-connector as explained further below. Additionally, or alternatively, the connector may in particular be a locking connector and the counter-connector may be a locking counter-connector as explained further below. A general reference to a connector may equally refer to an anti-rotation connector and/or a locking connector. Similarly, a general reference to a counter-connector may equally refer to anti-rotation counter-connector and/or a locking counter-connector. It is noted that a connector being an anti-rotation connector does not exclude the same connector from being also a locking connector and vice versa. Similarly, a counter-connector being an anti-rotation counter-connector does not exclude the same counter-connector from being also a locking counter-connector and vice versa.

In an aspect, an anti-rotation connector for releasable coupling a field device with an inner room of a fluidic component via an anti-rotation counter-connector in accordance with the present disclosure includes a connector stub. The connector stub has a stub body, the stub body extending along a connector axis between a proximal stub end and a distal stub end. The anti-rotation connector furthers include a through-going access channel, the access channel being coaxial with respect to the connector axis and extending through the stub body. The anti-rotation connector further includes a first connector-sided anti-rotation structure, the first connector-sided anti-rotation structure being arranged at a lateral stub body surface. The first connector sided anti-rotation structure is rotational symmetric of order two with respect to the connector axis. The first connector-sided anti-rotation structure is configured for engagement with a first counter-connector-sided anti-rotation structure of the anti-rotation counter-connector by relatively displacing the anti-rotation connector and the counter-anti-rotation connector towards each other.

In a further aspect, an anti-rotation counter-connector for releasable coupling a field device with an inner room of a fluidic component via an anti-rotation connector in accordance with the present disclosure, includes a counter-connector body. The counter-connector body having a stub-receiving receptacle. The stub-receiving receptacle extends along a counter-connector axis, the counter-connector axis extending between a proximal counter-connector end and a distal counter-connector end. The stub-receiving receptacle is open at the proximal counter-connector end. The anti-rotation counter-connector further includes a first counter-connector-sided anti-rotation structure, the first counter-connector-sided anti-rotation structure being arranged at a lateral receptacle surface. The first counter-connector-sided anti-rotation structure is rotational symmetric of order two with respect to the counter-connector axis. The first counter-connector-sided anti-rotation structure is configured for engagement with a first connector-sided anti-rotation structure of the anti-rotation connector by relatively displacing the counter-connector and the connector towards each other.

An anti-rotation connector arrangement may include an anti-rotation connector and an anti-rotation counter-connector in accordance with the present disclosure. Such anti-rotation connector and anti-rotation counter-connector are favorably releasable coupable, wherein in a coupled configuration the connector axis is aligned with the counter-connector axis and the stub body is at least partly received within the stub-receiving receptacle.

Via the engagement of the connector-sided anti-rotation structure and the counter-connector sided anti-rotation structure, the connector and the counter-connector are circumferentially respectively rotatory locked with respect to each other in a coupled state. Typically, the engagement between connector-sided anti-rotation structure and counter-connector sided anti-rotation structure does not lock the connector and counter-connector in axial direction.

Since the first connector-sided anti-rotation structure of an anti-rotation connector and the first counter-connector-sided anti-rotation structure of an anti-rotation counter-connector are each rotationally symmetric of order two, the anti-rotation connector and the anti-rotation counter-connector are releasable coupable in a rotationally locked manner and in two and only two distinct alternative coupling orientations between the anti-rotation connector and the anti-rotation counter-connector. The two alternative coupling orientations are generally rotated against each other by 180 degrees with respect to the connector axis and counter-connector axis, respectively.

The before-described type of anti-rotation connectors and anti-rotation counter-connectors anti-rotation counter-connector with two distinct relative orientations are particularly useful for coupling an actuator, for example an electric servo drive as field device with a rotatable member, such as a damper or regulation body, with both the regulation body and the actuator having an operational rotation angle of 90 degrees. In this case, the two alternative coupling orientations will in any case result in the same rotational position of the movable member. Independent in which of the two permissible orientations the actuator is coupled the movement of the movable member upon actuation will be identical. The actuator can accordingly be mounted in the position that is best suited under the given circumstances, without requiring any subsequent configuration or programming for reflecting the mounting orientation of the actuator. Other coupling orientations are prevented by the cooperation of the connector-sided and counter-connector-sided anti-rotation structures.

The first connector-sided anti-rotation structure and the first counter-connector-sided anti-rotation structure are generally designed and shaped to rotationally lock the connector, in particular anti-rotation connector and the counter-connector, in particular anti-rotation counter-connector in a bidirectional manner, that is, in both rotational directions with respect to the connector axis and counter-connector axis, respectively.

In a further aspect, a locking connector for releasable coupling a field device with an inner room of a fluidic component via a locking counter-connector in accordance with the present disclosure includes a connector stub, the connector stub having a stub body, the stub body extending along a connector axis between a proximal stub end and a distal stub end. The locking connector further includes a through-going access channel, the access channel being coaxial with respect to the connector axis and extending through the stub body. The locking connector further includes a circumferential locking structure, the circumferential locking structure being arranged at a lateral stub body surface.

In a further aspect, a locking counter-connector for releasable coupling a field device with an inner room of a fluidic component via a locking connector in accordance with the present disclosure includes a counter-connector body, the counter-connector body having a stub-receiving receptacle. The stub-receiving receptacle extends along a counter-connector axis, the counter-connector axis extending between a proximal counter-connector end and a distal counter-connector end. The stub-receiving receptacle is open at the proximal counter-connector end. The locking counter-connector further includes a locking member, the locking member being arranged movable to the counter-connector body between a locking position and an alternative releasing position. The locking member is generally arranged to interfere with the locking connector and thereby axially lock the locking connector and the locking counter-connector with respect to each other in the locking position and not to interfere with the locking connector in the releasing position. The interference with the locking connector in the locking position may in particular be an interference respectively engagement with the circumferential locking structure of the stub-body that is received in the stub-receiving receptacle. The locking member interfering respectively not interfering with the locking counter-connector refers to a configuration where the stub body is at least partly received within the stub-receiving receptacle.

In a particular embodiment, the locking member protrude into the stub-receiving receptacle in the locking position and does not protrude into the stub-receiving receptacle in the releasing position. The locking member may, however, protrude into the stub-receiving receptacle in particular in a peripheral region thereof without interfering with the locking connector.

A locking connector arrangement may include a locking connector and a locking counter-connector in accordance with the present disclosure. Such locking connector and locking counter-connector are releasable coupable, wherein in a coupled configuration the connector axis is aligned with the counter-connector axis and the stub body is at least partly received within the stub-receiving receptacle.

The locking member of the locking counter-connector and the locking structure of the locking connector are configured for engagement, in particular releasable engagement, with each other. By protruding into the stub-receiving receptacle in the locking position, the locking member of the locking counter-connector may engage with the circumferential locking structure of a locking connector, thereby establishing a positive locking. By moving the locking member into its releasing position, such engagement may be canceled, thereby allowing the locking connector and the locking counter-connector to be separated.

The cooperation of the circumferential locking structure of the connector and the locking member of the counter-connector allows for a simple and reliable coupling and decoupling as explained in more detail below.

Via the engagement of the locking structure of the connector and the locking member of the counter-connector, the connector and the counter-connector are locked with respect to each other in axial direction in the coupled state. Typically, the engagement between locking structure and locking member does not lock the connector and counter-connector with respect to each other in circumferential direction respectively rotatory.

As will be discussed in more detail further below, the engagement between the locking member of the locking counter-connector and the locking structure of the locking connector may in some embodiments occur without dedicated user action during the coupling, while releasing the engagement may require a dedicated user action respectively user operation.

For coupling a connector with a counter-connector by relatively displacing the connector and the counter-connector towards each other, the connector axis and the counter-connector axis are aligned with each other, respectively coincide. The displacement may include a displacement of the counter-connector and/or a field device that includes the counter-connector in the proximal direction towards the connector, with the connector staying in position respectively being fixed. In the following description, this kind of coupling is generally assumed. Equivalently, however, the displacement may include a displacement of the connector in the distal direction towards the counter-connector, with the counter-connector and/or a field device that includes the counter-connector being fixed. Further, a combined movement may be used with the counter-connector being displaced in the proximal direction towards the connector and the connector being displaced in the distal direction towards the counter-connector. Prior to the coupling being established the counter-connector respectively a field device including the counter-connector is positioned distal with respect to the connector respectively a fluidic component to which the connector is mounted, with the proximal counter-connector end facing the distal connector end, and with the connector axis being generally aligned with the counter-connector axis.

As used throughout this document, the expression “distal direction” refers to a direction pointing from the connector respectively a fluidic component to which the connector is mounted towards the counter-connector respectively a field device including the counter-connector. Similarly, the expression “proximal direction” refers to a direction pointing from the counter-connector respectively a field device including the counter-connector towards the connector respectively a fluidic component to which the connector is mounted.

In a particular design of an anti-rotation connector, the anti-rotation connector includes a circumferential locking structure, the circumferential locking structure being arranged at the lateral stub body surface. In such design, the anti-rotation connector also has the functionality of a locking connector respectively is also a locking connector.

In a particular design of an anti-rotation counter-connector, the anti-rotation counter-connector further includes a locking member, the locking member being arranged movable to the counter-connector body between a locking position and an alternative releasing position. The locking member is arranged to interfere with the connector and thereby axially lock the locking connector and the locking counter-connector with respect to each other in the locking position and not to interfere with the locking connector in the releasing position. In such design, the anti-rotation counter-connector also has the functionality of a locking counter-connector respectively is also a locking counter-connector.

In a particular design of a locking connector, the locking connector further includes a first connector-sided anti-rotation structure, the first connector-sided anti-rotation structure being arranged at the lateral stub body surface, the first connector sided anti-rotation structure being rotational symmetric of order two with respect to the connector axis. In such design, the first connector-sided anti-rotation structure is configured for engagement with a first counter-connector-sided anti-rotation structure of the locking counter-connector by relatively displacing the locking connector and the locking counter-connector and the counter-connector with respect to each other. In such design, the locking connector also has the functionality of an anti-rotation connector respectively is also an anti-rotation connector.

In a particular design of a locking counter-connector, the locking counter-connector further includes a first counter-connector-sided anti-rotation structure, the first counter-connector-sided anti-rotation structure being arranged at the lateral receptacle surface, the first counter-connector-sided anti-rotation structure being rotational symmetric of order two with respect to the counter-connector axis. In such a design, the first counter-connector-sided anti-rotation structure is configured for engagement with a first connector-sided anti-rotation structure of the locking connector by relatively displacing the locking counter-connector and locking the connector towards each other. In such design, the locking counter-connector also has the functionality of an anti-rotation counter-connector respectively is also an anti-rotation counter connector.

It is noted that features and embodiments that are specifically discussed in the context of an anti-rotation connector respectively anti-rotation counter-connector may equally be present in a locking connector respectively locking counter-connector. Similarly, features and embodiments that are specifically discussed in the context of locking connector respectively locking counter-connector may equally be present in an anti-rotation connector respectively anti-rotation counter-connector.

In an embodiment of a connector, the connector being an anti-rotation connector and/or a locking connector, the lateral stub body surface is an outer surface. Similarly, in an embodiment of a counter-connector, the counter-connector being an anti-rotation counter-connector and/or a locking counter-connector, the lateral receptacle surface is an inner surface. In alternative designs, however, the lateral stub body surface is an inner surface and the lateral receptacle surface is an outer surface.

In an embodiment of a connector, the connector being an anti-rotation connector and/or a locking connector, the connector further includes a control shaft, wherein the control shaft is rotatable arranged in the access channel and in a fluidically sealed manner. Such an embodiment is particularly useful if the fluidic component includes a rotatable member within its flow channel, for example a rotatable regulation body of a control valve or a rotatable damper arranged inside a gas conduit. Here, the control shaft may serve as linkage element for rotatory coupling the rotatable member with an actuator, for example a servo drive. The rotatable control shaft may be permanently coupled with the rotatable member and/or form a part thereof. Alternatively, however, the control shaft may be configured for engagement, in particular in a rotatory locked manner, with a further control shaft that is part of the rotatable member and the actuator. In such design, the control shaft serves as linkage element between the further control shaft. The control shaft may generally be freely rotatable without stops. Alternatively, however, a rotation angle of the control shaft may be limited by stops in accordance with a permissible rotation angle respectively rotatory end positions of the rotatable member, e. g. 180 degrees or in particular 90 degrees in some embodiments.

In designs where the connector is used for coupling a sensor, such as a temperature sensor, a pressure sensor or a flow sensor with the inner room of a fluidic component, no control shaft may be present but the access channel may be configured to receive the sensor or part thereof in a fluidically sealed manner.

In a particular embodiment of a connector with a control shaft, the connector being an anti-rotation connector and/or a locking connector, an engagement part of the control shaft is rotationally symmetric of order two with respect to the connector axis. This type of embodiment is particularly useful in the context of a rotatable member with a rotation angle between its rotatory end positions of 90 degrees and in combination with a connector-sided anti-rotation structure and counter-connector-sided anti-rotation structure respectively an anti-rotation connector and anti-rotation counter-connector, since it allows a coupling with the control shaft in two and only two distinct coupling orientations opposite to each other respectively rotated by generally 180 degrees with respect to each other. In a particular design, the engagement part projects over the distal stub end in distal direction.

The engagement part of the control shaft and a proximal end of the control shaft that may be configured for engaging a rotatable member of a fluidic component may be designed for different relative orientations with respect the connector axis, thereby allowing different relative orientations between the rotatable member and an actuator, respectively be provided in different variants. By way of example, two different variants of a connector may be designed in which the engagement part and an engagement structure that is configured for engaging the rotatable member are rotated with respect to each other by 90 degrees. While the adapter offers in both cases to different orientations for coupling a field device, in particular an actuator, the orientation of the field device (which may have a main extension direction and be, e. g., substantially cuboid) would differ by 90 degrees. By using either of the adapters respectively control shaft designs, four options are in total accordingly available for mounting the field device without any influence on the rotatable member.

In an embodiment of a connector, the connector being an anti-rotation connector and/or a locking connector, the connector further includes a connector mounting structure, in particular a mounting flange. The connector mounting structure is arranged at the proximal stub end. The connector mounting structure is configured for mounting the anti-rotation connector to the fluidic component. The connector mounting structure, in particular mounting flange, may for example be a mounting plate and project from the connector stub generally transverse to the connector axis and may be designed for mounting to the fluidic components, e.g. using screws, rivets, and/or by way of clamping. In a particular embodiment, the mounting structure may be designed for snap-on mounting to the fluidic component. A mounting surface that is configured for attaching to the fluidic component may be shaped complementary respectively to match an outer contour of the fluidic component and may, for example, be concave cylindrical for matching a cylindrical gas conduit.

In a further embodiment of a connector, the connector being an anti-rotation connector and/or a locking connector, the connector is formed integrally with a fluidic component, the fluidic component being in particular a valve with a rotatable regulation body, or a damper arrangement with a rotatable damper.

In an embodiment of a counter-connector, the counter-connector being an anti-rotation counter-connector and/or a locking counter-connector, the counter-connector includes a field device receiving receptacle. The field device receiving receptacle extends along the counter-connector axis and is open at the distal counter-connector end. The field device receiving receptacle and the stub-receiving receptacle merge into one other within the counter-connector.

Due to the field device receiving receptacle and the stub-receiving receptacle merging one into another, they form, in combination, a continuous through-going opening that extends between the proximal counter-connector end and the distal counter-connector end and extends along the counter-connector axis. Via the field device receiving receptacle, an element of a field device as explained further below may project from the distal side into the counter-connector.

The lateral stub body surface and the lateral receptacle surface are generally complementary to each other and are in circumferential contact in a coupled state of connector and counter-connector, thereby ensuring a good mechanical coupling. In an embodiment of a connector, the connector being an anti-rotation connector and/or a locking connector, the lateral stub body surface is generally cylindrical or rotational symmetric of an even order with respect to the connector axis. Similarly, in an embodiment of a counter-connector, the counter-connector being an anti-rotation counter-connector and/or a locking counter-connector, the lateral receptacle surface is generally cylindrical or rotational symmetric of an even order with respect to the counter-connector axis. For this kind of design, it is ensured, together with the interaction of the first connector-sided anti-rotation structure and the first counter-connector-sided anti-rotation structure, that connector and the counter-connector are coupable in two alternative coupling orientations are generally rotated against each other by 180 degrees as explained before under circumferential contact between the lateral stub body surface and the lateral receptacle surface. In a further design, it is the lateral stub body surface and the lateral receptacle surface are in each case oval respectively have an oval cross section.

In an embodiment of a connector, in particular an anti-rotation connector or a locking connector with additional anti-rotation functionality, the first connector-sided anti-rotation structure includes a number of anti-rotation notches, the anti-rotation notches each extending from the lateral stub body surface into the stub body and in parallel with the connector axis. Similarly, in an embodiment of a counter-connector, in particular an anti-rotation counter-connector or a locking counter-connector with additional anti-rotation functionality, the first counter-connector-sided anti-rotation structure includes a number of anti-rotation protrusions, the anti-rotation protrusions each extending from the lateral receptacle surface. The anti-rotation notches and anti-rotation protrusions are favorably shaped complementary with respect to each other. Generally, the number of anti-rotation notches and the number of anti-rotation protrusions correspond to each other.

When coupling the connector and the counter-connector, the anti-rotation protrusions and the anti-rotation notches come into engagement with each other pairwise respectively in a one-to-one manner. Favorably, the anti-rotation notches and anti-rotation protrusions are smooth and free from undercuts and/or protrusions and with a uniform cross section along their extension, thereby enabling a smooth coupling and decoupling between connector by a movement as explained before. In a design where the lateral stub body surface is an outer surface and the lateral receptacle surface is an inner surface, the anti-rotation notches extend from the lateral sub body surface inwards respectively towards the connector axis, while the anti-rotation protrusions extend from the lateral receptacle surface inwards respectively towards the counter-connector axis. In an alternative design where the lateral stub body surface is an inner surface and the lateral receptacle surface is an outer surface, the anti-rotation notches may extend from the lateral sub body surface outwards respectively away from the connector axis, while the anti-rotation protrusions extend from the lateral receptacle surface outwards respectively away from the counter-connector axis.

In alternative designs, the arrangement of anti-rotation notches and anti-rotation protrusions is reversed as compared to the before-described arrangement. That is, the first connector-sided anti-rotation structure may include a number of anti-rotation protrusions and the first counter-connector sided anti-rotation structure includes a number of anti-rotation notches. For the lateral stub body surface being an outer surface the anti-rotation protrusions may in this case extend from the lateral stub body surface outwards respectively away from the connector axis. Similarly, for the lateral receptacle surface being an inner surface, the anti-rotation notches may in this case extend from the lateral receptacle surface outwards, respectively away from the counter-connector axis.

For the anti-rotation protrusions and anti-rotation notches, a variety of designs may be used. By way of example, the anti-rotation protrusions and anti-rotation notches may have a circular cross section (transverse to the connector axis respectively counter-connector axis). In an alternative design, the anti-rotation notches may have a generally rectangular or square cross section. The anti-rotation protrusions may in this case have a complementary rectangular or square cross section, or may for example be realized by cylindrical pins that extend transverse to the connector axis or counter-connector axis, respectively.

The number of anti-rotation notches and anti-rotation protrusions bay be selected in accordance with the overall design. In principle, a number of two anti-rotation notches respectively two anti-rotation protrusions may be present that are arranged diametrically opposed to each other with respect to the connector axis and counter-connector axis, respectively.

In a particular design of a connector with anti-rotation notches, the connector being an anti-rotation connector and/or a locking connector, the number of anti-rotation notches includes a first set of anti-rotation notches and a second set of anti-rotation notches, wherein the first and second set of anti-rotation notches includes in each case at least two anti-rotation notches arranged circumferentially spaced apart at the lateral stub body surface. The first and second set of anti-rotation notches are arranged diametrically opposite to each other with respect to the connector axis. Similarly, in a particular design of a counter-connector, in particular an anti-rotation counter-connector, with anti-rotation protrusions, the number of anti-rotation protrusions includes a first set of anti-rotation protrusions and a second set of anti-rotation protrusions, wherein the first and second set of anti-rotation protrusions includes in each case at least two anti-rotation protrusions arranged circumferentially spaced apart at the lateral receptacle surface. The first and second set of anti-rotation protrusions are arranged diametrically opposite to each other with respect to the counter-connector axis. In alternative similar designs, the first and second set of anti-rotation notches includes in each case a number of more than two anti-rotation notches, while the first and second set of anti-rotation protrusions includes in each case a number of more than two anti-rotation protrusion. Providing sets of at least two anti-rotation protrusions respectively anti-rotation notches may be favorable in applications where the connector-sided anti-rotation structure and the counter-connector-sided anti-rotation structure need to absorb significant torques, at it may be the case, e.g., for the coupling of servo drives.

In an embodiment of a connector, the connector being in particular a locking connector or an anti-rotation connector with additional locking functionality, the circumferential locking structure includes a circumferential locking groove, the circumferential locking groove extending from the lateral stub body surface into the stub body, such forming a recess in the stub body. In particular, in embodiments where the connector is also an anti-rotation connector respectively has an anti-rotation functionality, the circumferential locking groove may be interrupted along its circumference by the ant-rotation notches. The locking groove generally extends at a constant axial position with respect to the connector axis. In alternative designs, the circumferential locking structure includes a circumferential locking protrusion, for example a circumferential locking bulge and the locking member includes a corresponding locking groove or locking recess that releasably engages the locking protrusion upon coupling.

In a further embodiment of a connector, the connector being in particular a locking connector or an anti-rotation connector with additional locking functionality, the circumferential locking structure includes a circumferential locking step, the locking step being arranged at the lateral stub body surface. A laterally outwards-protruding locking flange may be arranged at the distal end of the stub body for providing the circumferential locking step. Such design is particularly favourable for realizing a locking with a number of spaced apart engagement regions as discussed elsewhere in more detail. When coupling with the counter-connector, the locking member of the counter-connector, for example a locking slider, may engage under the locking flange respectively with the locking step formed by the lateral stub body surface and an adjacent e.g. ring-shaped engagement surface of the locking flange. The distal end surface of the stub body may serve as abutment. Further the distal end surface of the stub body is generally transverse to the connector axis.

In embodiment of a connector, the connector being an anti-rotation connector and/or locking connector, the stub body is chamfered at the distal stub end. When coupling the connector with a counter-connector as explained before, the chamfer comes into contact with the locking member of the counter-connector and, upon further displacing the connector and the counter-connector towards each other, forces the locking member from its locking configuration respectively locking position into its releasing configuration respectively releasing configuration, in particular against the force of a locking member biasing member.

In a particular embodiments of a counter-connector, in particular a locking counter-connector or an anti-rotation counter-connector with additional locking functionality, the locking member is configured to interact with the circumferential locking structure in a number of engagement regions in the locking position, wherein the engagement regions are circumferentially spaced apart with respect to each other, or with a single engagement region. In a particular design with a number of engagement regions, the number of engagement regions is three. The engagement regions are circumferentially spaced apart respectively circumferentially distributed around the connector axis and counter-connector axis, respectively. A number of circumferentially distributed engagement regions has proven to provide a particularly stable coupling without tilting or shaking. In further particular embodiments, the number of engagement regions is one or two.

In an embodiment, the locking member includes a number of tongues, in particular to diametrically opposite tongues, with each tongue defining a respective engagement regions. An inner contour of the locking member, for example of a locking slider cutout of a locking slider, may be partly delimited by the tongues. The tongues may extend parallel to the movement direction of the locking slider for moving between the locking position and the releasing position. In order not to interfere with the connector in the releasing position, the tongues may in each case for example be positioned in a respective recess of the stub body of the connector. Such recesses may be anti-rotation notches.

In particular embodiments of a counter-connector, in particular a locking counter-connector or an anti-rotation counter-connector with additional locking functionality, the locking member includes a locking slider, the locking slider being movable between the locking position and the releasing position by a linear movement transverse to the counter-connector axis. The locking slider is configured for engagement with the locking structure of a connector. In axial direction, the locking slider is favorably arranged within the counter-connector body, respectively, the counter-connector body extends in proximal and distal direction from the locking slider. Inner surfaces of the counter-connector body may serve as sliding and guiding surfaces for the locking slider.

In a particular embodiment of a locking slider, the locking slider is generally U-shaped in a viewing direction transverse to the counter-connector axis and transverse to the movement direction of the locking slider between the locking position and the releasing position. The legs are spaced apart with respect to the counter-connector axis, with either of the legs being a proximal locking slider leg and the other of the legs being a distal locking slider leg.

In alternative embodiments, the locking member may be arranged to move between the locking position and the releasing position by a different kind of movement, such as a pivoting movement.

In a particular design of a locking slider, the locking slider has a locking slider cutout, wherein a contour of a lateral receptacle surface of the stub-receiving receptacle is, in a viewing direction along the counter-connector axis, seated within a contour of the locking slider cutout in the releasing position. In an embodiment with an U-shaped locking slider as mentioned before, the locking slider cutout may be arranged in a proximal locking slider leg.

The contour of the stub-receiving receptacle being seated within the contour of the locking slider cutout in the releasing position implies that the locking slider cutout is somewhat wider as compared to the stub receiving receptacle. In this way, the full cross section of the stub-receiving receptacle is available for inserting the connector stub without the locking slider interfering. When the locking slider moves subsequently from the releasing position into the locking position, it engages the locking structure of the connector. In embodiments of a connector where a locking structure includes a circumferential locking groove as mentioned before, an engagement region of the locking slider may engage with the locking groove. The engagement region is generally formed by a region that peripherally delimits the locking slider cutout. Instead of a single engagement region, a number of separate and axially distributed engagement regions may be foreseen as mentioned before.

In an embodiment of a counter-connector, in particular a locking counter-connector or an anti-rotation counter-connector with additional locking functionality, the counter-connector further includes a locking member biasing member, in particular at least one locking member biasing spring. The at least one locking member biasing member biasing the locking member towards the locking position. In such embodiment, the locking member generally is in the locking position but may be moved into the releasing position by a dedicated action, in particular a user action. If more than one biasing member, in particular more than one biasing spring is present, such biasing members may act in parallel. The at least one biasing member may be arranged respectively act between the locking member, in particular a locking slider, and the counter-connector body, with the counter-connector body serving as abutment.

In an embodiment of a counter-connector, in particular a locking counter-connector or an anti-rotation counter-connector with additional locking functionality, the locking member includes or is coupled with a first manual release member, in particular a first manual release pushbutton, the first manual release member being configured for moving the locking member from the locking position into the releasing position upon actuation. In a design where the locking member includes an U-shaped locking slider as mentioned before, a first manual release pushbutton may be favorably be formed by the base of the U that connects the legs. The first manual release member favorably projects out of the counter-connector body in particular in a direction transverse to the counter-connector axis to enable easy and convenient access by a user also under constrained conditions.

By providing a first manual release member of the before-described type, decoupling is possible in a simple and convenient manner also under constraint conditions by simply operating the first manual release member respectively pressing the first manual release pushbutton, without requiring direct sight and without relying on additional tools.

In a particular embodiment with a first manual release member as mentioned before, the counter-connector includes a second manual release member. The second manual release member has an elongated second release member pusher. The locking member includes in this design a release surface, the release surface facing the second release member pusher and being arranged oblique with respect to the counter-connector axis. Upon displacing the second manual release member towards the proximal counter-connector end, the second release member pusher forces the locking member towards the releasing position via the release surface. The second manual release member pusher may in particular be tubular. In the context of a field device with a control shaft receptacle as discussed further below, the second release member pusher may extend in parallel alignment with and spaced apart from the control shaft receptacle

The second manual release member may in particular include a second manual release pushbutton that may be connected or formed integrally with the second manual release member pusher. By operating the second manual release member pushbutton, the second manual release member pusher is moved in proximal direction along the counter-connector axis towards the proximal counter-connector end. By providing a second manual release member, an alternative for releasing the coupling between fluidic component and field device respectively between connector and counter-connector is provided. Thereby, releasing the coupling is simplified in particular under constrained conditions. The movement when operating the second manual release member is favorably transverse to the movement direction of a first manual release member. In an alternative design, the second manual release member pusher is directly accessible and operable by a user. For such design, the separate second manual release member pushbutton as mentioned before may be omitted.

In an alternative design, the second manual release member is designed such that pulling the second manual release member, respectively displacing the manual release member in the distal direction respectively away from the proximal counter-connector end results in the locking member moving from the locking position into the releasing position.

In a particular embodiment of a field device with a second manual release member, the field device further includes a second release member biasing member, in particular a second release member biasing spring, the second release member biasing member biasing the second release member pusher away from the release surface. In this way, it is ensured that a dedicated user action is required for releasing the coupling via the second manual release member.

In an embodiment of a counter-connector, in particular an anti-rotation counter-connector or a locking counter-connector with additional anti-rotation functionality, the first counter-connector-sided anti-rotation structure includes a number of anti-rotation protrusions, the anti-rotation protrusions each extending from the lateral receptacle surface. The anti-rotation protrusions are designed and arranged for engaging with anti-rotation notches of the connector as described before. In a particular embodiment, the anti-rotation protrusions are in each case split into a first protrusion part and a second protrusion part, wherein the first protrusion part and the second protrusion part are in each case circumferentially aligned with each other and are axially spaced apart with respect to the counter-connector axis. A part of the locking member may be arranged between the first protrusion parts and the second protrusion parts. In particular for an U-shaped locking slider as explained before, a leg of the locking slider with the locking slider cutout may be arranged axially between the first and second protrusion parts.

In an embodiment of a counter-connector, the counter-connector being an anti-rotation counter-connector and/or locking counter-connector, the counter-connector further includes further includes an alignment structure, in particular an alignment collar. The alignment structure surrounds the stub-receiving receptacle at the proximal counter-connector end. The alignment structure is arranged outside of the stub-receiving receptacle and extends the stub-receiving receptacle in proximal direction. The alignment structure is generally arranged symmetrically with respect to the counter-connector axis and around the opening of the stub-receiving receptacle at the proximal counter-connector end. The alignment structure is arranged such that the stub body of a connector respectively a distal part of the stub body may be received within an area delimited by the alignment structure without or little lateral play. For the alignment structure including a circumferential collar, the cross section of its inner space (transverse to the counter-connector axis) corresponds to the cross section of the stub body (transverse to the connector axis). For the stub body being generally cylindrical, the inner space that is laterally delimited by the alignment collar may accordingly also be cylindrical, with its dimeter corresponding to the diameter of the stub body. Instead of a continuous alignment collar, the alignment structure may realize, e.g., by a number of separate alignment posts that are arranged circumferential spaced apart, or a number of generally cylindrical wall elements.

An alignment structure as described serves the purpose of aligning and centering the counter-connector respectively a field device including the counter-connector with respect to the connector, in particular the connector body, when coupling the connector and the counter-connector. Thereby, the handling is improved in particular under constrained conditions and/or if the coupling needs to be done without direct view.

A field device may include a counter-connector, the counter-connector being in particular an anti-rotation counter-connector and/or locking counter-connector with a field device receiving receptacle as mentioned before. The field device may be an electro servo drive with a rotatory drive shaft, the rotatory drive shaft being an output member of the electric servo drive. The rotatory drive shaft projects into the field device receiving receptacle from the distal counter-connector end and in alignment with the counter-connector axis.

The servo drive may generally be designed as known in the art and typically includes an electric motor, for example an EC motor, a reduction gear and optionally control circuitry. In a particular embodiment, for example in HVAC safety applications, the electric servo drive may be a spring-return drive with a return spring as generally known in the art.

Via the counter-connector and a corresponding connector that is mounted to or part of a fluidic component, the field device may be releasably coupled with the fluidic component.

In a particular embodiment of a field device, in particular an electric servo drive as mentioned before, the rotatory drive shaft includes a control shaft receptacle, the control shaft receptacle extending along the counter-connector axis and being open at a proximal control shaft receptacle end, the control shaft receptacle being configured to receive the engagement part of a control shaft, in particular in a positive locking manner. The inner contour respectively cross section of the control shaft receptacle generally corresponds to the outer contour respectively cross section of the engagement part of the control shaft.

When coupling a field device with a control shaft receptacle as mentioned before, with a fluidic component respectively its connector, the engagement part of the control shaft is simultaneously received in the control shaft receptacle, thereby establishing a rotatory coupling. The positive locking between the rotatory drive shaft respectively control shaft and the control shaft is favorably a rotatory respectively radial locking, but no axial locking.

In a particular embodiment with the connector being an anti-rotation connector or a locking connector with additional anti-rotation functionality and the counter-connector being an anti-rotation counter-connector or a locking counter-connector with additional anti-rotation functionality, an inner contour respectively the cross section of the control shaft receptacle is rotationally symmetric of order two. For such design, the control shaft and the drive shaft may be coupled in exactly two distinct alternative coupling orientations.

In an embodiment of a field device, in particular an electric servo drive as mentioned before, the rotatory drive shaft is rotatable between a first end position and a second end position, the first and second end position being rotated with respect to each other by 90 degrees. This type of design is particularly advantageous in combination with a rotatable member with end positions that are also rotated with respect to each other by 90 degrees. That is, both the electric drive and the routable member have a rotatory operation angle of 90 degrees. The rotatable member may for example be the regulation body of a control valve or a damper as mentioned before. In combination with a connector and counter-connector with anti-rotation functionality as mentioned before, the electric servo drive may be coupled with the fluidic component in either of its two distinct coupling orientations, without requiring subsequent adjustment or configuration regarding the coupling orientation between servo drive and fluidic component.

### BRIEF DESCRIPTION OF THE DRAWINGS

The herein described invention will be more fully understood from the detailed description given herein below and the accompanying drawings which should not be considered limiting to the invention described in the appended claims. The drawings show:

FIG. 1a, an embodiment of a control valve with a connector in accordance with the present invention in a perspective view;

FIG. 1b a further embodiment of a control valve with a connector in accordance with the present invention in a perspective view;

FIG. 1c a further embodiment of a control valve with a connector in accordance with the present invention in a perspective view;

FIG. 1d a further embodiment of a control valve with a connector in accordance with the present invention in a perspective view;

FIG. 1e a further embodiment of a control valve with a connector in accordance with the present invention in a perspective view;

FIG. 2 the valve and connector of FIG. 1b in a further perspective view;

FIG. 3 the valve and connector of FIG. 1b in a view from distal toward proximal;

FIG. 4a a damper arrangement with a connector in accordance with the present invention and an electric servo drive with a counter-connector in accordance with the present invention in a decoupled state;

FIG. 4b the arrangement corresponding to FIG. 4a with the electric servo drive and the damper arrangement being in the coupled state;

FIG. 5a control valve with a connector in accordance with the present invention and an electric servo drive with a counter-connector in accordance with the present invention in a decoupled state;

FIG. 5b the arrangement corresponding to FIG. 5a with the electric servo drive and the control valve being in the coupled state;

FIG. 6a a counter-connector in accordance with the present invention in a perspective view;

FIG. 6b the counter-connector of FIG. 6a in a perspective cut-away view;

FIG. 7 a locking slider of a counter-connector pursuant to FIG. 6a, 6b.

FIG. 8 a drive shaft of an electric servo drive in accordance with the present invention in a perspective view;

FIG. 9 the drive shaft of FIG. 8 in a perspective cut-away view;

FIG. 10 an assembly with counter-connector and drive shaft in accordance with the present invention;

FIG. 11 a view of an electric servo drive from proximal towards distal;

FIG. 12 a further electric servo drive with a counter-connector in accordance with the present invention;

FIG. 13 a further embodiment of a control valve with a connector in accordance with the present invention in a perspective view;

FIG. 14 the arrangement of FIG. 13 in a perspective side view;

FIG. 15 the arrangement of FIG. 13 in a perspective bottom view;

FIG. 16 the arrangement of FIG. 13 in a side view with indicated sectional plane;

FIG. 17 the arrangement of FIG. 13 in the releasing position in a sectional view;

FIG. 18 the arrangement of FIG. 13 in the locking position in a sectional view;

FIG. 19 a perspective sectional view corresponding to FIG. 18;

FIG. 20 the arrangement of FIG. 13 in the locking position in a further sectional view.

### DESCRIPTION OF THE EMBODIMENTS

In the following, like reference signs are used to refer to like or substantially like components parts, or features. Further, like or substantially like components, parts or features may not be individually referenced in all figures.

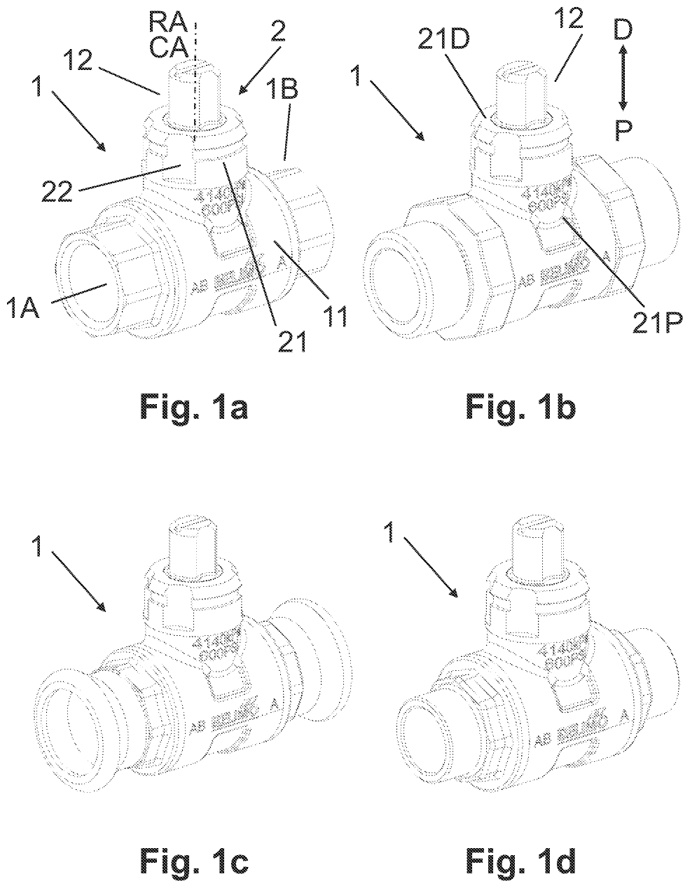

FIGS. 1a, 1b, 1c, 1d, 1e, 1e show different designs of a control valve 1 as exemplary fluidic components in a perspective view. The control valves 1 are designed for control the flow of a heat transport fluid, such as water, air, steam, glycol, or any mixture thereof and are designed for use in an HVAC system. The control valves 1 include in each case a valve body 11 that form the housing of the control valve and a regulation body (not visible) that is rotatably arranged therein. In the shown designs, the regulation body is generally spherical or ball-shaped and the control valve 1 is a ball valve. The regulation body is rotatable about a rotation axis A between a first end position and a second end position, with an operation angle of 90 degrees between the first end position end the second end position. The inner room that is defined by the valve body 11 and in which the regulation body is arranged is the inner room of the valve 1.

The control valve 1 as shown in FIGS. 1a, 1b, 1c, 1d is in each case a two-way valve has two ports, namely an A-port 1A and a B-Port 1B, with the effective cross section of a flow channel connecting the A-port 1A and the B-port 1B depending on the rotatory position of the regulation body. The design is in each case identical with exception of the ports. In the design of FIG. 1a, the A-Port 1A and the B-Port 1B are threaded female ports, while in the design of FIG. 1b, the A-Port 1A and the B-Port 1B are threaded male ports. In the design of FIG. 1c the A-port 1A and the B-Port 1B are press-fit ports, and in the design of FIG. 1d, the A-port 1A and the B-Port 1B are soldering ports. The control valve 1 in the design of FIG. 1e is a three—way valve with an A-port 1A, a B-Port 1B, and an AB-port 1AB. In dependence of the rotatory position of the regulation body, either, both or none of the A-Port 1A and the B-port 1B may be fluidically coupled with the AB-port 1AB. It is noted that the control valve may also be of a different type and be designed, for example as butterfly valve.

The regulation body includes or is rigidly coupled in each case with a control shaft 12 that projects out of the valve body 11 in distal direction D with a rotation axis RA. By rotating the control shaft 12 about the rotation axis RA, the regulation body that is arranged inside the valve body 11 is rotated accordingly.

In each of the shown designs of control valve 1, a connector 2 is formed integrally with the control valve 1 respectively its valve body 11. The connector 2 is in each case designed in an identical manner and serves as both anti-rotation connector and locking connector as described before.

The connector 2 includes a connector stub with a stub body 21 extends from the valve body 11 in distal direction. The stub body 21 has a distal stub end 21D. The stub body 21 further has a proximal stub end 21P where the stub body 12 merges into the valve body 11. The stub body 21 is generally cylindrical with a connector axis CA as symmetry axis. The connector axis CA coincides with the rotation axis RA. The control shaft 12 projects in distal direction through a through-going access channel (not referenced) that is coaxial with the connector axis CA in a fluidic sealed and rotatable manner, with an engagement part 121 projecting in distal direction beyond the distal stub end 21D.

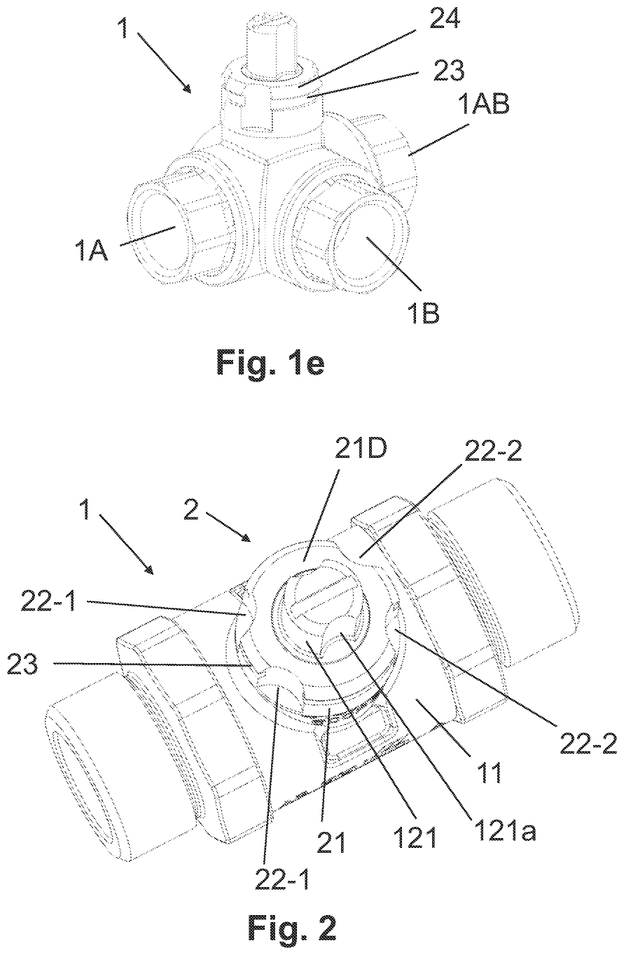

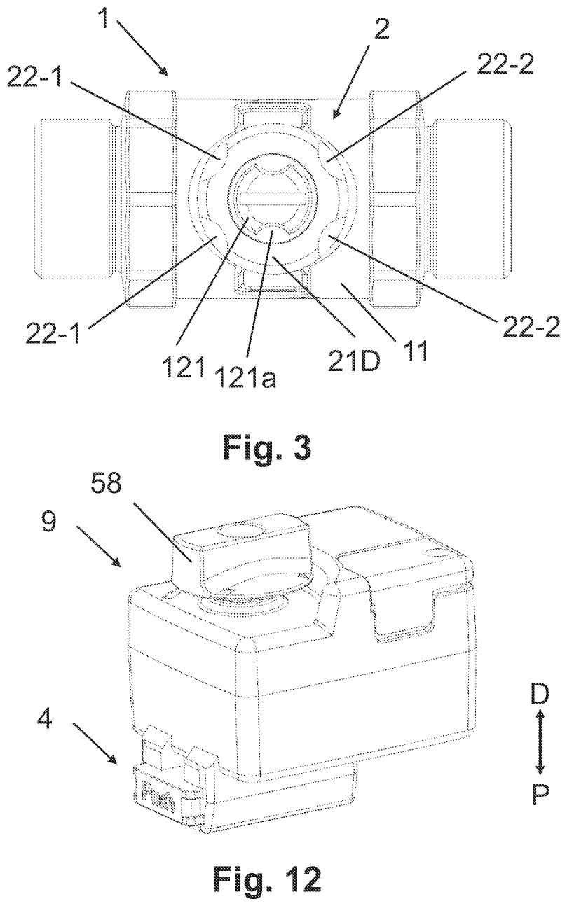

In the following, reference is additionally made to FIG. 2 and FIG. 3, showing a control valve 1, exemplarily the control valve of FIG. 1b together with the integrally formed connector 2 in a further perspective view and a top view (viewing direction from distal towards proximal).

The connector 2 includes a first connector-sided anti-rotation structure which includes a number of anti-rotation-notches 22 (see, e.g., FIG. 1a) that extend in this design from a lateral outer stub body surface into the stub body 21, towards and in parallel alignment with the connector axis CA: The anti-rotation notches 22 extend towards the distal stub end 21D. In the shown design, the anti-rotation notches 22 have a cross section (transverse to the connector axis CA) defining a circular arc.

The number of anti-rotation notches 22a is divided into a first set of anti-rotation notches with two anti-rotation notches 22-1 and a second set of anti-rotation notches 22-2 (see FIGS. 2, 3). While the four anti-rotation notches 22a are arranged circumferentially distributed at the lateral stub body surface, the angle (as measured with respect to the connector axis CA) respectively the circumferential distance between neighboring anti-rotation notches 22 is not equal. The angle between the two anti-rotation notches 22-1 is identical to the angle between the two anti-rotation notches 22-2 and is exemplarily smaller than 90 degrees. The angle between an anti-rotation notch 22-1 to a neighboring anti-rotation notch 22-2, however, is larger as compared to the angle between the two anti-rotation notches 22-1 respectively between the two anti-rotation notches 22-2 and is accordingly larger than 90 degrees. Each anti-rotation notch 22-1 of the first set of anti-rotation notches is arranged diametrically opposite with an anti-rotation notch 22-2 of the second set of anti-rotation notches.

As discussed further below in the context of a counter-connector, a counter-connector may have a number of anti-rotation protrusions that are generally arranged in a pattern corresponding to the pattern of anti-rotation notches 22.

As best visible in FIGS. 2, 3, the engagement part 121 of the control shaft 12 has a generally cylindrical design respectively circular cross section, with two diametrically opposite notches 121, resulting in the engagement part being rotationally symmetric of order two with respect to the connector axis.

Further, a circumferential locking groove 23 (referenced in FIGS. 1e, 2) extends from the lateral stub body surface into the stub body 21. By engagement with a locking member of a counter-connector as explained further below, the circumferential locking groove 23 serves the purpose of axially locking the connector 2 with a counter-connector. Further, the stub body 21 is chamfered at the distal stub end 21D with a circumferential stub chamfer 24. The stub chamfer 24 serves the purpose of moving a locking member, in particular a locking slider of a counter-connector from its locking position into its releasing position when coupling the connector with a counter-connector.

In variants where the connector is an anti-rotation connector but no locking connector, the locking groove 23 and the stub chamfer 24 may be omitted. In embodiments where the connector 2 is a locking connector but no anti-rotation connector, the connector-sided anti-rotation structure with anti-rotation notches 22 may be omitted.

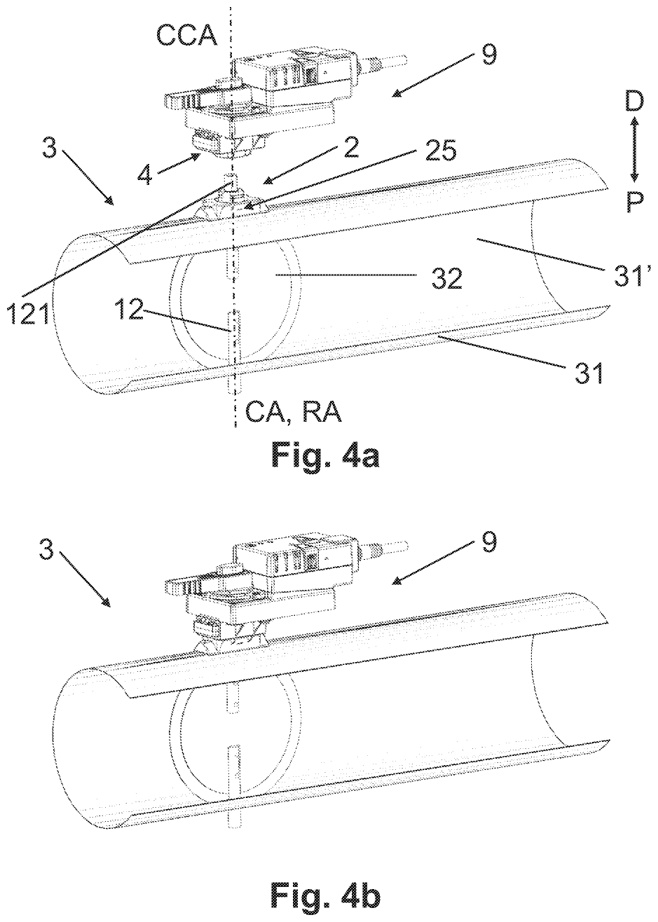

In the following, reference is additionally made to FIGS. 4a, 4b, showing a further exemplary component in form of a damper arrangement 3. The damper arrangement 3 includes an exemplarily tubular and cylindrical gas conduit 31 with an inner room 31′ and a damper 32 rotationally arranged therein. The damper 32 is rotatable around a rotation axis RA between a first end position and a second end position by 90 degrees via control shaft 12 and is a rotatable member. The control shaft 12 is rigidly connected to the damper 32 and projects in distal direction out of the gas conduit 31. The damper arrangement 3 may, for example, be part of an HVAC system, with the damper 32 regulating an air stream, and/or part of a fire protection system, with the damper 32 being a fire protection damper and/or a smoke extractor damper. At the outside of the gas conduit 31, a connector 2 as explained before is mounted, with the connector 2 being an anti-rotation connector and locking connector of generally the before-discussed design. The connector axis CA coincides with the rotation axis A and the control shaft 12 projects in distal direction through the access channel of the connector 2. In the shown design, the connector 2 includes a connector mounting flange 25 via which the connector 2 is mounted to the outside of the cylindrical gas conduit 31. A connector with a mounting flange may further be used as a retrofit adapter in combination with a fluidic component, e.g. valve, that is originally not designed for use in combination with a counter-connector in accordance with the present disclosure respectively with a filed device having such counter-connector.

The damper arrangement 3 is shown together with an electric servo drive 9, exemplary a spring return drive, for moving the damper 32 between its end positions. The electric servo drive includes a counter-connector 4 as discussed further below in more detail. In FIG. 4a, the electric servo drive is shown in a position and orientation prior to coupling with the damper arrangement 3 or after decoupling, with the electric servo drive spaced apart in distal direction with respect to the damper arrangement 3. In FIG. 4b, the electric servo drive 9 is coupled with the damper arrangement 3 via the connector 2 and counter-connector 4, respectively. The counter-connector 4 has a counter-connector axis CCA that is aligned respectively coincides with the connector axis CA as well as the rotation axis RA in the coupled state.

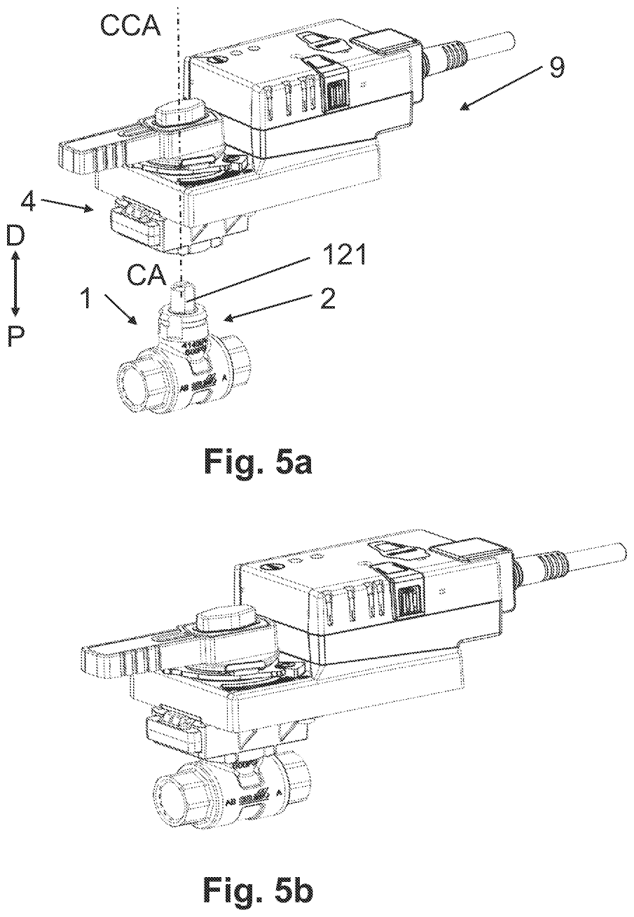

FIG. 5a, 5b shows a similar arrangement as FIG. 4a, 4b, but with a control valve 1 rather than a damper arrangement 3 as fluidic component.

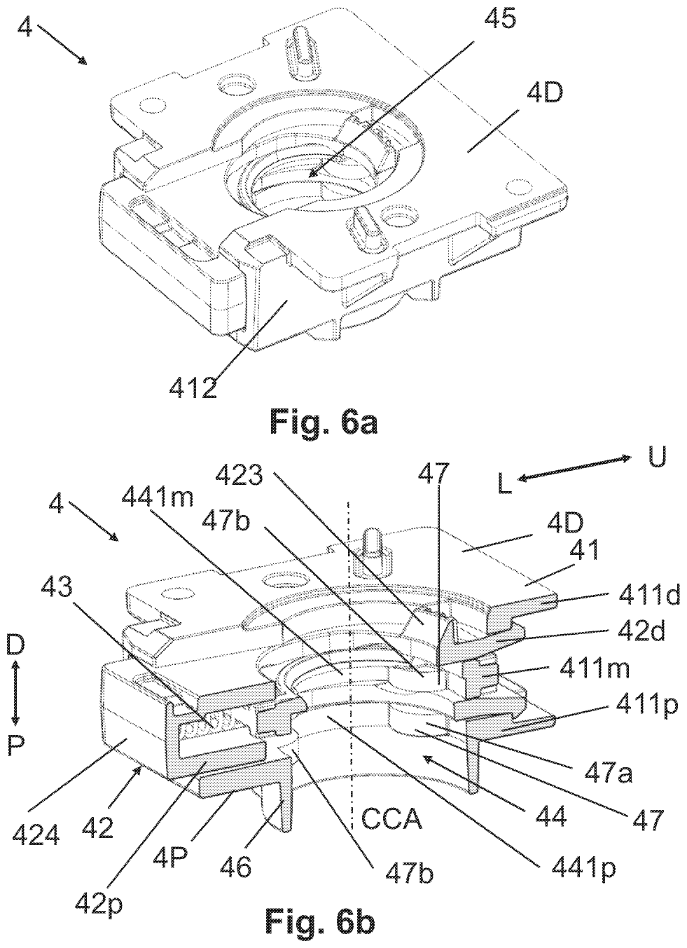

In the following, reference is additionally made to FIGS. 6a, 6b, showing a counter-connector 4 in a perspective view (FIG. 6a) and perspective cut-away view (FIG. 6b). The shown counter-connector is both an anti-rotation counter-connector as well as a locking counter-connector. The counter-connector 4 as shown in FIG. 4a, 4b, 5a, 5b may be of such design.

The counter-connector 4 comprises in this embodiment three generally plate-shaped section, namely a distal section 411d, a middle section 411m, and a proximal section 411p that extend parallel with respect to each other and are spaced apart along the counter-connector axis CCA and extend further in each case transverse to the counter-connector axis CCA. The outer (distal pointing) side of the distal section 411d forms the distal counter-connector end 4D, and the outer (proximal pointing) side of the proximal section 411p forms the proximal counter-connector end 4P of the counter-connector 4. The distal section 411d, middle section 411m and proximal section 411p are connected via side walls 412 that extend in parallel with the counter-connector axis CCA. The counter-connector body 41 may, for example, be made from a single piece of injection-molded plastics. The counter-connector 4 includes a stub-receiving receptacle 44 that extends along the counter-connector axis CCA and is open at the proximal counter-connector end 4P and further field device receiving receptacle that is open at the distal counter-connector end 4D. The stub-receiving receptacle 44 and the field device receiving receptacle 45 merge into one another, thereby forming a continuous through-going channel that extends between the proximal counter-connector end 4P and the distal counter-connector end 4D.

The circumferential surfaces 441p that delimits the stub-receiving receptacle 44 in the proximal section 411p and the circumferential surface 441m that delimits the stub-receiving receptacle 44 in the middle section 411m of the counter-connector body 41 form, in combination a lateral receptacle surface that is in this design a generally cylindrical inner surface and is complementary to the lateral stub body surface as mentioned before.

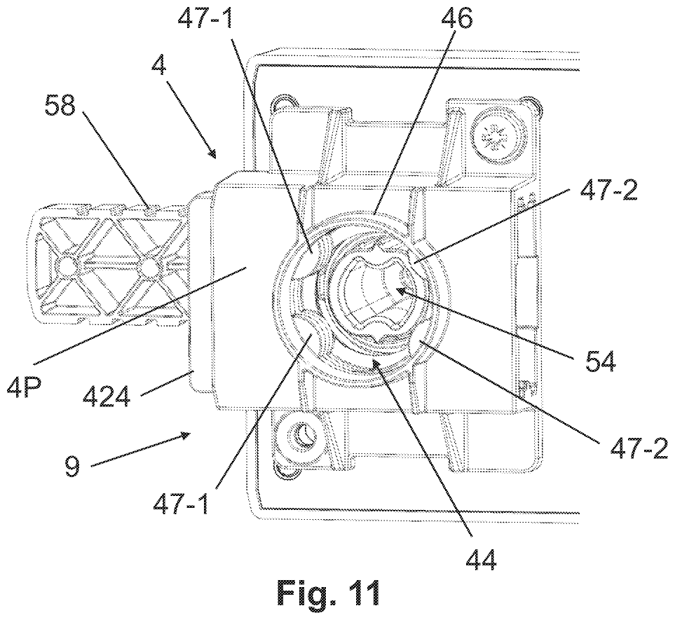

A number of anti-rotation protrusions 47 extend into the stub-receiving receptacle 44: From the proximal section 411p of the counter-connector body 41 respectively the proximal section 441p of the lateral receptacle surface extends a number of first protrusion parts 47a and from the middle section 411m of the counter-connector body 41 respectively middle section 441m of the lateral receptacle surface extends a number of second protrusion parts 47b, with a first protrusion part and associated second protrusion part 47b forming, in combination an anti-rotation protrusion 47. The first protrusion part 47a and the second protrusion part 47b are in each case circumferentially aligned with each other. The number and pattern of anti-rotation protrusions corresponds to the number and pattern of anti-rotation notches 22. The number of anti-rotation protrusions 47 is accordingly also split into a first set of anti-rotation protrusions 47-1 and a second set of anti-rotation protrusions 47-2 that are circumferentially distributed in an arrangement as explained before in the context of anti-rotation notches of the connector 2 (see FIG. 11).

In the shown embodiment, an alignment structure in form of an alignment collar 46 is arranged around the opening of the stub-receiving receptacle and is formed integrally with the proximal section 411p of the counter-connector body. The alignment collar projects from the proximal counter-connector end 4P in proximal direction.

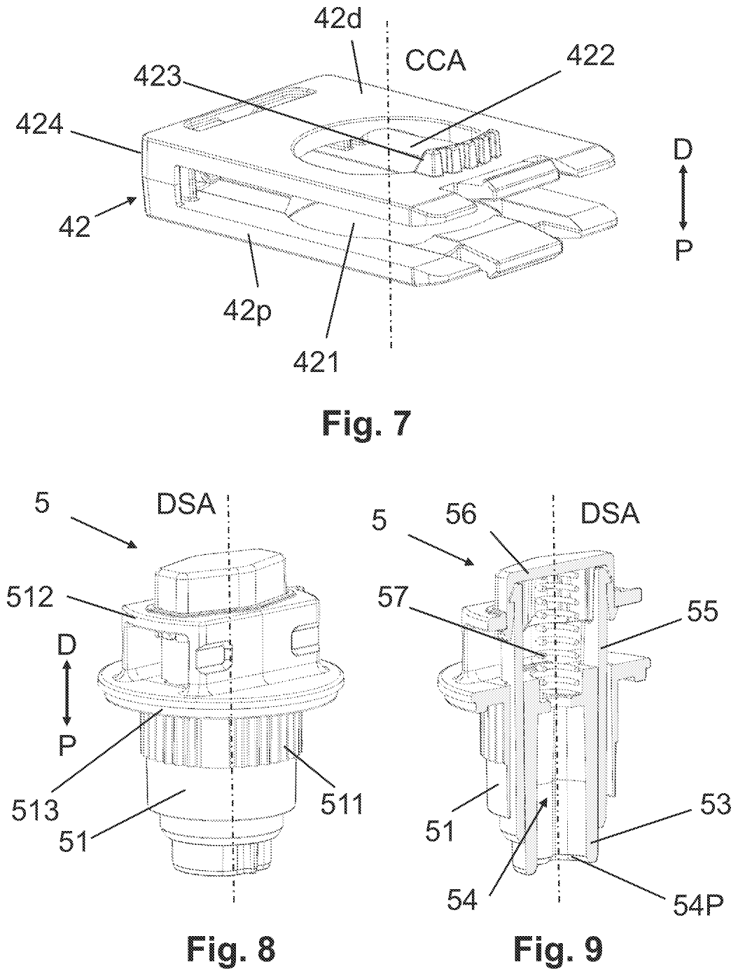

In the following, reference is additionally made to FIG. 7, showing a locking slider 42 as embodiment of a locking member of the counter-connector 4 in a perspective view. The locking slider 42 includes in the shown design two generally plate-shaped section, namely a distal section 42d and a proximal section 42p that extend parallel with respect to each other and are spaced apart along the counter-connector axis CCA and extend further in each case transverse to the counter-connector axis CCA. The overall design of the locking slider 42 is U-shaped with a base that connects the proximal section 42p and the distal section 42d of the locking slider 42 serving as first manual release pushbutton 424 as explained further below. As best visible in FIG. 6b, the proximal section 42p of the locking slider 42 is in axial direction located between the proximal section 411p and the middle section 411m of the counter-connector body 41, while the distal section 42d of the locking slider 42 is in axial direction located between the middle section 411m and the distal section 411d of the counter-connector body 41. The proximal section 42p of the locking slider 42 is further axially arranged between the first protrusion parts 47a and the second protrusion parts 47b.

The locking slider 42 is further linearly movable transverse to the counter-connector axis CCA in a locking direction L and an unlocking direction U. A position on the locking direction establishes a locking position and an end position in the unlocking direction establishes an unlocking position of the locking slider 42. Via exemplary two parallel arranged locking slider biasing springs 43 in parallel arrangement (only one visible in FIG. 6b) that acts between the first manual release pushbutton 424 and the middle section 411m of the counter-connector body 42, the locking slider 42 is biased into the locking position.

As best visible in FIG. 7, the proximal section 42p of the locking slider comprises a locking slider cutout 421 and the distal section 42d of the locking slider 42 comprises a locking slider field device cutout 422 through which the counter-connector axis CCA extends.

In the following, reference is additionally made to FIG. 8 and FIG. 9, showing a rotatory drive shaft 5 in a perspective view (FIG. 8) and a perspective cut-away view (FIG. 9), respectively. The rotatory drive shaft 5 is the output member of the electric servo drive 9. The rotatory drive shaft has in the shown embodiment a generally tubular design with a central drive shaft axis DSA. In an assembled state, the drive shaft axis DSA coincides with the counter-connector axis CCA. The rotatory drive shaft 5 comprises an outer drive shaft member drive shaft member 51 and an inner drive shaft member in coaxial arrangement. The outer drive shaft member 51 carries a toothing 511 that is, in an assembled configuration, in engagement with a further toothed wheel of the reduction gear of the electric servo drive 9. The outer drive shaft member 51 further includes a bearing and support member 513 that projects in radial direction and serves for bearing and supporting the drive shaft 5 with respect to the structure of the electric servo drive 9.

The inner drive shaft member 53 includes a control shaft receptacle 54 that is open at a proximal control shaft receptacle end 54P. An inner contour of the control shaft receptacle 54 respectively its cross section corresponds to the outer contour respectively cross section of the engagement part 121 of the control shaft 12 as explained before, thereby enabling the engagement part 121 to be received by the control shaft receptacle 54 in rotationally locked manner.

An elongated second release member pusher 55 is radially arranged between the outer drive shave shaft member 51 and the inner drive shaft member 53. In the shown design, the second release member pusher 55 is also of tubular design. At the distal end of the second release member pusher 55 a second manual release pushbutton 56 that also forms the distal end of the rotatory drive shaft 5 is arranged. The outer drive shaft element 51 has at its distal side an engagement piece 512 that rotatory engages with the second manual release pushbutton 56, thereby rotatory coupling respectively locking the second manual release pushbutton 56 and the second release member pusher 55 with the outer drive shaft element 51. The second release member pusher 55 is further rotationally coupled respectively licked with respect to the inner driver shaft member 43, such that the inner drive shaft member 53 is rotatory coupled respectively locked with the outer drive shaft member 51 via the second release member pusher 55 as intermediate element. The second release member pusher 55 and the second manual release pushbutton 56, however, are axially movable with respect to the outer drive shaft member 51 and inner drive shaft member 53, respectively. A second manual release member biasing spring 57 acts between the second manual release pushbutton 56 and the inner drive shaft member 53, thereby biasing the second manual release pushbutton in distal direction.

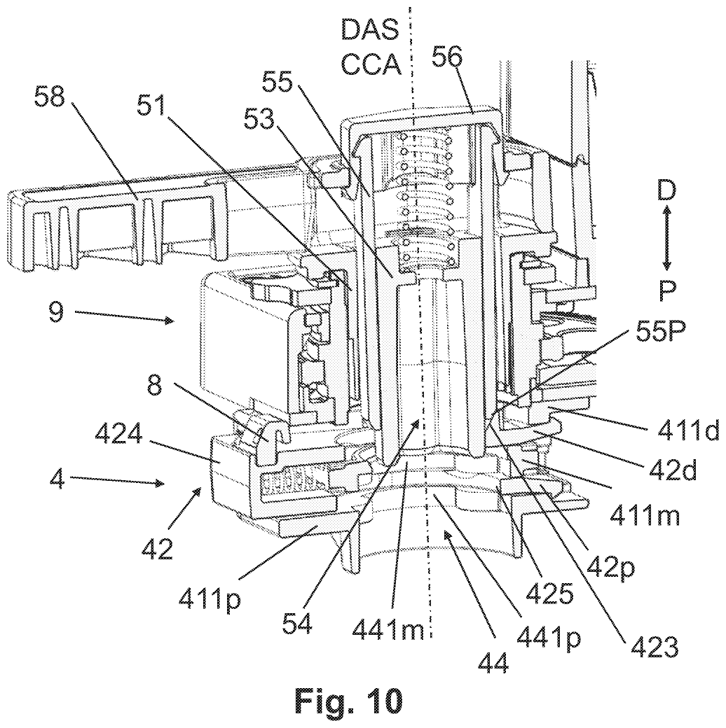

In the following, reference is additionally made to FIGS. 10,11. FIG. 10 shows the counter-connector 4 together with the rotatory drive shaft 5 and further elements of the electric servo drive 9 in an assembled state and a perspective cut-away view. FIG. 11 shows a view from proximal towards distal of the electric servo drive 9 with counter-connector 4.

The rotatory drive shaft 5 and the control shaft receptacle 54 project into the counter-connector 4 from the distal connector end 4D via the field device receiving receptacle (see also FIG. 6a). When a connector stub of a connector 2 is inserted into the field device receiving receptacle 45 from the proximal side, the control shaft receptacle 54 axially overlaps with the engagement part 121 of the control shaft 12, respectively at least a distal portion of the engagement part 121 is seated within the control shaft receptacle 54.

In FIG. 10, the locking slider 42 is shown in the locking position. In this configuration, the proximal section 42p of the locking slider 42 radially projects into the stub receiving receptacle 44 with an engagement region 425 that forms part of the periphery of the locking slider cutout 421 (best visible in FIG. 7). As the connector stub 21 is inserted into the stub receiving receptacle 44 with a relative movement of the connector 2 in distal direction with respect to the counter-connector 4, the first protrusion parts 47a will come into engagement with the anti-rotation notches 22 in a one-to-one manner, thereby axially locking the field device 9 respectively the counter-connector 4 and the fluidic component respectively the connector 2 with respect each other. As the movement continuous, the stub chamfer 24 will contact a proximal edge of the locking slider cutout 421, thereby forcing the locking slider 42 against the force of the locking member biasing spring 43 into the unlocking position where the engagement region 425 does not project into the stub receiving receptacle 44 and the stub receiving receptacle is accordingly free to receive the stub body. As the movement continuous also the second protrusion parts 47b will come into engagement pairwise engagement with the anti-rotation notches 22. As the proximal section 42p is axially aligned with the circumferential locking groove 23, the locking slider 42 is displaced into the locking position under the force of the locking member biasing spring 43, such that the engagement region 425 engages the circumferential locking groove 23, thereby axially locking the connector 2 and the counter-connector 4 with respect to each other. By pushing the first manual release pushbutton, the locking slider 42 may be displaced into the unlocking position. The locking slider field device cutout 422 (best visible in FIG. 7) is dimensioned and arranged such that it does not interfere with the rotatory drive shaft 5 but allows the rotatory drive shaft 5 respectively the inner drive shaft element 53 to project in any case through the locking slider field device cutout.

In order to prevent the first manual release pushbutton 424 unintentionally an optional pushbutton locker 8 is foreseen that locks the locking slider 42 in the locking position and needs to be removed before the first manual release pushbutton 424 can be pressed.

Alternatively, to the first manual release pushbutton 424, the second manual release pushbutton 56 may be pressed. This will cause the second release member pusher 55 to move, against the force of the second release member biasing spring 57, into the proximal direction. As the proximal end 55P of the second release member pusher 55 contacts the release surface 423 that projects from the distal section 42d of the locking slider 42 in general distal direction and oblique to the counter-connector axis (corresponding to the movement axis of the second release member pusher 55), the locking slider 42 is forced into the unlocking position.

In the shown design, a manual operation handle 58 is further provided that is connected to the rotatory drive shaft respectively the engagement piece 512 of the outer drive shaft element (see also FIGS. 4a, 4b, 5a, 5b).

In variants of the counter-connector 4 where the counter-connector 4 is an anti-rotation counter-connector but no locking counter-connector, locking slider 42 may be omitted.

In embodiments where the counter-connector is a locking counter-connector but no anti-rotation counter-connector, the counter-connector sided anti-ration structure with anti-rotation protrusions structure with anti-rotation protrusions 47 may be omitted.

In the following, reference is additionally made to FIG. 12, showing a further embodiment of an electric servo drive 9 with a counter-connector 4 as discussed before. The electric servo drive, however, is an ordinary electric servo drive rather than a spring-return drive. Further, no second manual release member is foreseen in this example and the manual operation handle 58 is realized by a knob.

The connector 2 and counter-connector 4 have so far been described in the context with an electric servo drive 9 as field device. They may, however, also be used for coupling other kinds of field devices, in particular sensor devices, such as temperature sensors, pressure sensors, or flow sensors, and/or air quality sensors (e. g. PM sensors, CO2 sensors, VOC sensors). In such applications, an elongated part of the sensor may be arranged in the access channel in a fluidically sealed manner rather than a rotatable control shaft.

Particularly in the context of the sensor being a particulate matter (PM) sensor, it is noted that such sensors generally require a defined orientation with respect to the fluid carried by the fluid component, while the before-discussed type of anti-rotation connector and anti-rotation counter-connector allow coupling between connector respectively fluidic component and counter-connector respectively field device in two alternative orientations relative to each other. For coupling for example a PM sensor, the connector-sided anti-rotation structure and counter-connector sided anti-rotation structure may be replaced by anti-rotation structures that are designed to allow a coupling of connector and counter-connector in one orientation only respectively are rotationally symmetric of order one. For other types of sensors where the orientation is not decisive, the before-described type of anti-rotation structure may be used.

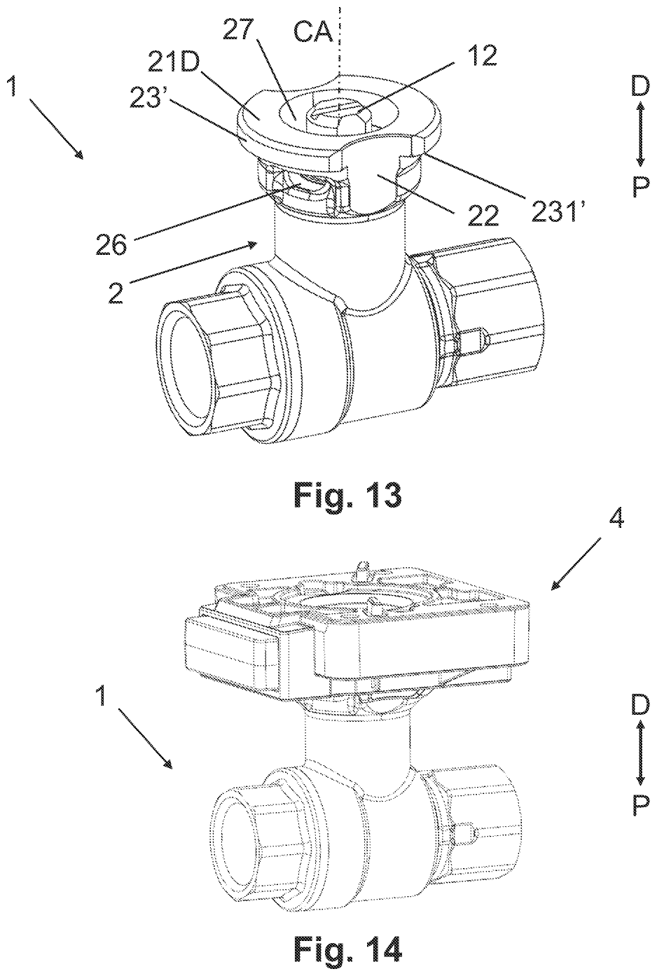

In the following, reference is additionally made to FIG. 13 to FIG. 20, depicting further embodiments of a control valve 1 with a connector 2 and corresponding counter-connector 4. Apart from the here-described aspects, the design generally corresponds to the before-discussed embodiments.

FIG. 13 shows the control valve 1 in a perspective view. Apart from the connector 2, the design generally corresponds to the design as shown, e.g. in FIG. 1a and discussed above. In the design of FIG. 13, the circumferential locking structure is realized by an outwards protruding locking flange 23′ at the distal stub end. The ring-shaped proximal surface of the locking flange 23′ forms together with the thereto adjacent section of the lateral stub body surface an engagement step 231′ as discussed further below.

Further, the access channel that receives the control shaft 12 is stepped and is accordingly wider respectively has a larger diameter in a distal section. A circumferential groove 27 is accordingly present between the control shaft 12 and the circumferential inner surface of the access channel. In order to allow the removal of liquid, in particular condensed water that tends to accumulate, an optional liquid removal opening 26 is provided that connects the circumferential groove 27 with the environment. Further, two diametrically opposed anti-rotation notches 22 are exemplarily foreseen instead of four notches in the design shown in FIG. 1a. Like in the design of FIG. 1a, the anti-rotation notches 22 have exemplarily a cross section (transverse to the connector axis CA) defining a circular arc. The corresponding anti-rotation protrusions 47 (referenced in FIG. 15) have a corresponding. complementary, exemplarily cylindrical, contour at least at a part of its outer surface for a rotatory locking.

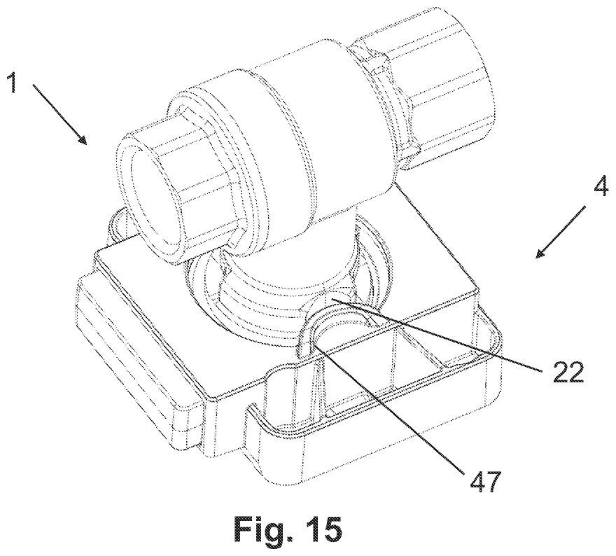

FIG. 14 and FIG. 15 show the control valve 1 and a thereto coupled counter connector 4 in a perspective side view and bottom view, respectively. In particular FIG. 15 shows the engagement of the anti-rotation protrusions 47 with the anti-rotation notches 22 (only one protrusion and one notch visible).

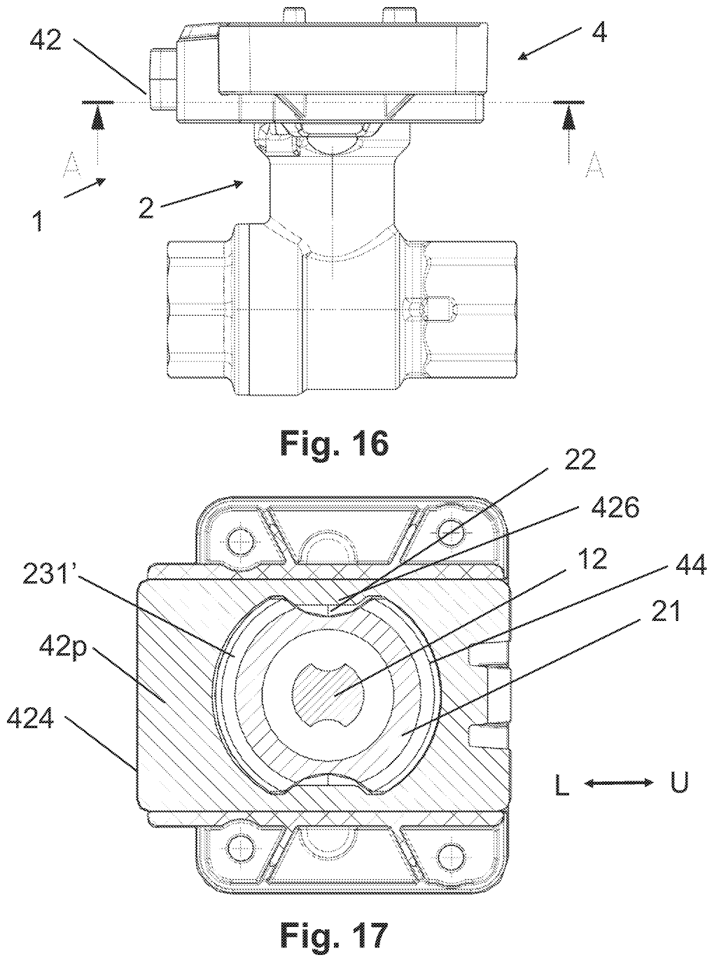

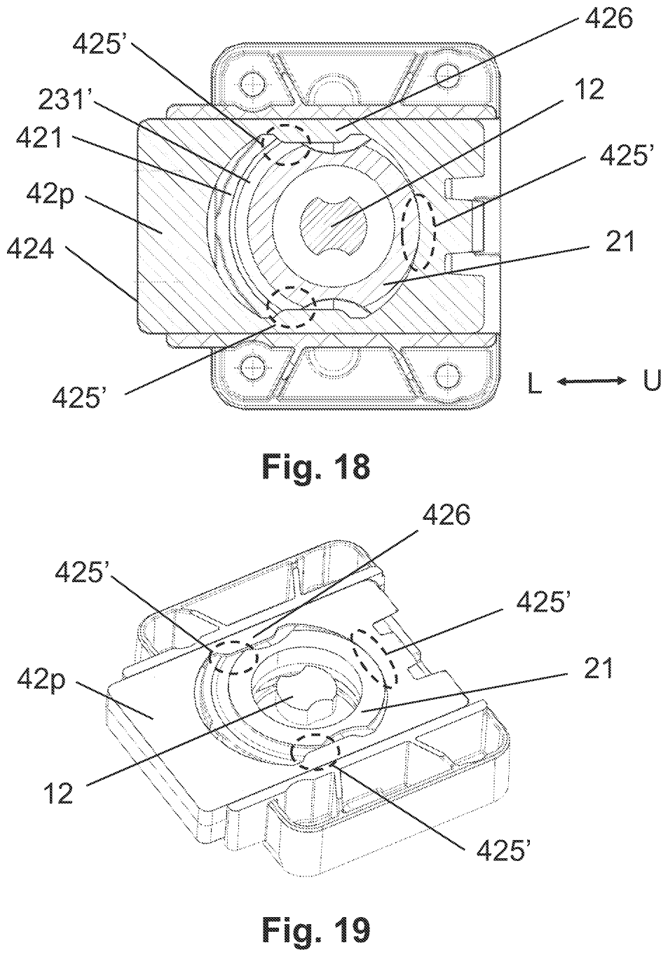

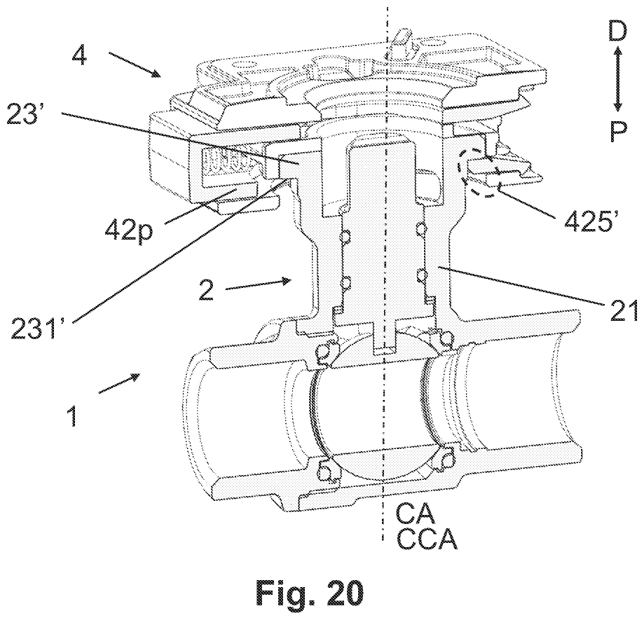

FIG. 16 shows a corresponding side view with a referenced sectional plane A-A that extends transverse to the connector axis and counter connector axis, and through the proximal section 42p (referenced in FIGS. 17, 18, 19) of the locking slider 42. FIG. 17 shows the cross sectional view A-A in the releasing position and FIG. 18 in the locking position in each case in a bottom view. FIG. 19 shows a perspective sectional view corresponding to FIG. 18. FIG. 20 shows the locking position in a perspective sectional view the connector axis CA and counter-connector axis CCA laying in the sectional plane.

The inner contour of the locking slider cutout 421 (referenced in FIG. 18) is in the shown embodiment partly delimited by two diametrically opposite tongues 426 that extend generally parallel to the movement direction of the locking slider 42 for moving between the locking position and the releasing position.

In the releasing position as depicted in FIG. 17, the locking slider 42 respectively its plate-shaped proximal section 42p the locking slider does not interfere with the stub body 21, thereby allowing a relative axial movement between the connector 2 respectively stub 21 and the counter-connector 4. In this configuration, the tongues are at least partly positioned in the free space of the anti-rotation notches 22 and do accordingly not engage respectively interfere with the stub body 21.

In the locking position as depicted in FIGS. 18, 19, in contrast, the locking slider 42 interferes with the stub body 21 in an axial viewing direction. Specifically, the proximal section 42p of the locking slider 42 engages with the engagement step 231′ in three separate engagement regions 425′. At the side of the locking slider 42, two of the three engagement regions 425′ are formed by end sections of the tongues 426. By way of the engagement, the stub body 21 and accordingly the connector 2 are axially locked with respect to the counter-connector 4.

It is noted that the locking flange 23′ is not necessarily circumferentially through-going respectively continuous as depicted. It is sufficient if corresponding flange sections are present in the engagement regions 425′ for both alternative coupling orientations.

### REFERENCE SIGNS

1 control valve
1A A-port
1B B-port
1AB AB-port
11 valve body
12 control shaft
121 engagement part
121a notch
2 connector
21 stub body
21D distal stub end
21P proximal stub end
22 anti-rotation notch
22-1 anti-rotation notch (first set)
22-2 anti-rotation notch second set
23 locking groove
23′ locking flange
231′ engagement step
24 stub chamfer
25 connector mounting flange
26 liquid removal opening
27 circumferential groove
3 damper arrangement
31 gas conduit
31′ inner room of gas conduit
32 damper
4 counter-connector
4D distal counter-connector end
4P proximal counter-connector end
41 counter-connector body
411d distal section of counter-connector body
411m middle section of counter-connector body
411p proximal section of counter-connector body
412 side wall of counter-connector body
42 locking slider
42d distal section of locking slider
42p proximal section of locking slider
421 locking slider cutout
422 locking slider field device cutout
423 release surface
424 first manual release pushbutton
425, 425′ engagement region
426 tongue
43 locking member biasing spring
44 stub receiving receptacle
441p proximal section of lateral receptacle surface
441m middle section of lateral receptacle surface
45 field device receiving receptacle
46 alignment collar
47 anti-rotation protrusion
47-1 anti-rotation protrusion (first set)
47-2 anti-rotation protrusion (second set)
47a first protrusion part
47b second protrusion part
50 rotatory drive shaft
51 outer drive shaft element
511 toothing
512 engagement piece of outer drive shaft element
513 bearing and support member of outer drive shaft element
53 inner drive shaft member
54 control shaft receptacle
54P proximal control shaft receptacle end
55 second release member pusher
55P proximal end of second release member pusher
56 second manual release pushbutton
57 second release member biasing spring
58 manual operation handle
8 pushbutton locker
9 electric servo drive
D distal direction
L locking direction
U unlocking direction
P proximal direction
RA rotation axis
CA connector axis
CCA counter-connector axis
DSA drive shaft axis

What is claimed is:

1. An anti-rotation connector for releasably coupling a field device with an inner room of a fluidic component via an anti-rotation counter-connector and/or the field device, the anti-rotation connector comprising:
a connector stub having a stub body, the stub body extending along a connector axis between a proximal stub end and a distal stub end;
a through-going access channel that is coaxial with respect to the connector axis and extends through the stub body; and
a first connector-sided anti-rotation structure arranged at a lateral stub body surface and is rotationally symmetric of order two with respect to the connector axis,
wherein the first connector-sided anti-rotation structure is configured for engagement with a first counter-connector-sided anti-rotation structure of the anti-rotation counter-connector by relatively displacing the anti-rotation connector and the anti-rotation counter-connector towards each other.

2. The anti-rotation connector according to claim 1, wherein the lateral stub body surface is generally cylindrical or rotational symmetric of an even order with respect to the connector axis.

3. The anti-rotation connector according to claim 1, wherein the first connector-sided anti-rotation structure includes a plurality of anti-rotation notches that each extend from the lateral stub body surface into the stub body and in parallel with the connector axis.

4. The anti-rotation connector according to claim 3, wherein the plurality of anti-rotation notches includes a first set of anti-rotation notches and a second set of anti-rotation notches,
wherein the first and second set of anti-rotation notches each includes at least two anti-rotation notches arranged circumferentially spaced apart at the lateral stub body surface, and
wherein the first and second set of anti-rotation notches are arranged diametrically opposite to each other with respect to the connector axis.

5. The anti-rotation connector according to claim 1, wherein the lateral stub body surface is an outer surface.

6. The anti-rotation connector according to claim 1, further comprising a circumferential locking structure arranged at the lateral stub body surface.

7. The anti-rotation connector according to claim 6, wherein the circumferential locking structure includes a circumferential locking groove, the circumferential locking groove extending from the lateral stub body surface into the stub body to form a recess in the stub body.

8. The anti-rotation connector according to claim 1, wherein the stub body is chamfered at the distal stub end.

9. The anti-rotation connector according to claim 1, further comprising a control shaft that is rotatably arranged in the through-going access channel in a fluidically sealed manner.

10. The anti-rotation connector according to claim 9, wherein the control shaft has an engagement part, and the engagement part of the control shaft projects over the distal stub end in distal direction and is rotationally symmetric of order two with respect to the connector axis.

11. The anti-rotation connector according to claim 1, further comprising a connector mounting flange arranged at the proximal stub end, the connector mounting flange being configured for mounting the anti-rotation connector to the fluidic component.

12. The anti-rotation connector according to claim 1, wherein the anti-rotation connector is formed integrally with the fluidic component, the fluidic component being a valve with a rotatable regulation body or a damper arrangement with a rotatable damper.

13. An anti-rotation counter-connector for releasably coupling a field device with an inner room of a fluidic component via an anti-rotation connector, the anti-rotation counter-connector comprising:
a counter-connector body having a stub-receiving receptacle, the stub-receiving receptacle extending along a counter-connector axis, the counter-connector axis extending between a proximal counter-connector end and a distal counter-connector end, the stub-receiving receptacle being open at the proximal counter-connector end; and
a first counter-connector-sided anti-rotation structure arranged at a lateral receptacle surface and being rotational symmetric of order two with respect to the counter-connector axis,
wherein the first counter-connector-sided anti-rotation structure is configured for engagement with a first connector-sided anti-rotation structure of the anti-rotation connector by relatively displacing the anti-rotation counter-connector and the anti-rotation connector towards each other.

14. The anti-rotation counter-connector according to claim 13, wherein the lateral receptacle surface is generally cylindrical or rotationally symmetric of an even order with respect to the counter-connector axis.

15. The anti-rotation counter-connector according to claim 13, wherein the first counter-connector-sided anti-rotation structure includes a plurality of anti-rotation protrusions, each extending from the lateral receptacle surface.

16. The anti-rotation counter-connector according to claim 15, wherein the plurality of anti-rotation protrusions includes a first set of anti-rotation protrusions and a second set of anti-rotation protrusions,
wherein the first and second set of anti-rotation protrusions each includes at least two anti-rotation protrusions arranged circumferentially spaced apart at the lateral receptacle surface, and
wherein the first and second set of anti-rotation protrusions are arranged diametrically opposite to each other with respect to the counter-connector axis.

17. The anti-rotation counter-connector according to claim 13, wherein the lateral receptacle surface is an inner surface.

18. The anti-rotation counter-connector according to claim 13, further comprising a locking member arranged to be movable with respect to the counter-connector body between a locking position and a releasing position,
wherein, in the locking position, the locking member is arranged to interfere with a locking connector to axially lock the locking connector and a locking counter-connector with respect to each other and, in the releasing position, the locking member is arranged not to interfere with the locking connector.

19. The anti-rotation counter-connector according to claim 18, wherein the locking member includes a locking slider that is movable between the locking position and the releasing position by a linear movement transverse to the counter-connector axis.

20. The anti-rotation counter-connector according to claim 13, further comprising an alignment structure that surrounds the stub-receiving receptacle at the proximal counter-connector end.

21. The anti-rotation counter-connector according to claim 13, further comprising a field device receiving receptacle that extends along the counter-connector axis and is open at the distal counter-connector end,
wherein the field device receiving receptacle and the stub-receiving receptacle merge into one other within the anti-rotation counter-connector.

22. A field device being an electric servo drive with a rotatory drive shaft, the rotatory drive shaft being an output member of the electric servo drive, the field device comprising the anti-rotation counter-connector according to claim 21,
wherein the rotatory drive shaft projects into the field device receiving receptacle from the distal counter-connector end and in alignment with the counter-connector axis.

23. The field device according to claim 22, wherein the rotatory drive shaft includes a control shaft receptacle that extends along the counter-connector axis and is open at a proximal control shaft receptacle end,
wherein the control shaft receptacle is configured to receive an engagement part of a control shaft in a positive locking manner.

24. The field device according to claim 22, wherein the rotatory drive shaft is rotatable between a first end position and a second end position, the first and second end position being rotated with respect to each other by 90 degrees.

25. An anti-rotation connector arrangement comprising an anti-rotation connector and an anti-rotation counter-connector,
wherein the anti-rotation connector comprises:
a connector stub having a stub body, the stub body extending along a connector axis between a proximal stub end and a distal stub end;
a through-going access channel, the through-going access channel being coaxial with respect to the connector axis and extending through the stub body; and
a first connector-sided anti-rotation structure arranged at a lateral stub body surface and being rotationally symmetric of order two with respect to the connector axis,
wherein the anti-rotation counter-connector comprises:
a counter-connector body having a stub-receiving receptacle that extends along a counter-connector axis, the counter-connector axis extending between a proximal counter-connector end and a distal counter-connector end, the stub-receiving receptacle being open at the proximal counter-connector end; and
a first counter-connector-sided anti-rotation structure arranged at a lateral receptacle surface and being rotational symmetric of order two with respect to the counter-connector axis,
wherein the first connector-sided anti-rotation structure is configured for engagement with the first counter-connector-sided anti-rotation structure of the anti-rotation counter-connector by relatively displacing the anti-rotation connector and the anti-rotation counter-connector towards each other,
wherein the first counter-connector-sided anti-rotation structure is configured for engagement with the first connector-sided anti-rotation structure of the anti-rotation connector by relatively displacing the anti-rotation counter-connector and the anti-rotation connector towards each other,
wherein the anti-rotation connector and the anti-rotation counter-connector are releasably coupleable, and
wherein in a coupled configuration the connector axis is aligned with the counter-connector axis and the stub body is at least partly received within the stub-receiving receptacle.

26. A locking connector for releasably coupling a field device with an inner room of a fluidic component via a locking counter-connector and/or the field device, the locking connector comprising:
a connector stub having a stub body that extends along a connector axis between a proximal stub end and a distal stub end;
a through-going access channel that is coaxial with respect to the connector axis and that extends through the stub body; and
a circumferential locking structure arranged at a lateral stub body surface.

27. The locking connector according to claim 26, further comprising a control shaft that is rotatably arranged in the through-going access channel in a fluidically sealed manner.

28. The locking connector according to claim 27, wherein an engagement part of the control shaft is rotationally symmetric of order two with respect to the connector axis.

29. The locking connector according to claim 26, further comprising a connector mounting flange arranged at the proximal stub end, the connector mounting flange being configured for mounting the locking connector to the fluidic component.

30. The locking connector according to claim 26, wherein the locking connector is formed integrally with the fluidic component, the fluidic component being a control valve with a rotatable regulation body or a damper arrangement with a rotatable damper.

31. The locking connector according to claim 26, further comprising:
a first connector-sided anti-rotation structure arranged at the lateral stub body surface and being rotationally symmetric of order two with respect to the connector axis,
wherein the first connector-sided anti-rotation structure is configured for engagement with a first counter-connector-sided anti-rotation structure of the locking counter-connector by relatively displacing the locking connector and the locking counter-connector with respect to each other.

32. The locking connector according to claim 26, wherein the circumferential locking structure includes a locking step arranged at the distal stub end.

33. The locking connector according to claim 32, wherein a radially outward protruding locking flange is arranged at the distal stub end.

34. A locking counter-connector for releasably coupling a field device with an inner room of a fluidic component via a locking connector, the locking counter-connector comprising:
a counter-connector body having a stub-receiving receptacle that extends along a counter-connector axis, the counter-connector axis extending between a proximal counter-connector end and a distal counter-connector end, the stub-receiving receptacle being open at the proximal counter-connector end; and
a locking member arranged to be movable to the counter-connector body between a locking position and a releasing position,
wherein the locking member is arranged to interfere with the locking connector to axially lock the locking connector and the locking counter-connector with respect to each other in the locking position, and not to interfere with the locking connector in the releasing position.

35. The locking counter-connector according to claim 34, wherein the locking member is configured to interact with a circumferential locking structure in a plurality of engagement zones in the locking position, and
wherein the plurality of engagement zones are circumferentially spaced apart with respect to each other.

36. The locking counter-connector according to claim 35, wherein the plurality of engagement zones is three.

37. The locking counter-connector according to claim 34, wherein the locking member includes a locking slider, the locking slider being movable between the locking position and the releasing position by a linear movement transverse to the counter-connector axis.

38. The locking counter-connector according to claim 37, wherein the locking slider has a locking slider cutout, and
wherein a contour of a lateral receptacle surface of the stub-receiving receptacle is, in a viewing direction along the counter-connector axis, seated within a contour of the locking slider cutout in the releasing position.

39. The locking counter-connector according to claim 34, further comprising at least one locking member biasing spring, the at least one locking member biasing spring biasing the locking member towards the locking position.

40. The locking counter-connector according to claim 34, wherein the locking member includes or is coupled with a first manual release pushbutton that is configured for moving the locking member from the locking position into the releasing position upon actuation.

41. The locking counter-connector according to claim 40, wherein the locking counter-connector includes a second manual release member, the second manual release member having an elongated second release member pusher, and
wherein the locking member includes a release surface that faces the elongated second release member pusher and is arranged oblique with respect to the counter-connector axis such that, upon displacing the second manual release member towards the proximal counter-connector end, the elongated second release member pusher forces the locking member towards the releasing position via the release surface.

42. The locking counter-connector according to claim 41, wherein the locking counter-connector includes a second release member biasing spring, the second release member biasing spring biasing the elongated second release member pusher away from the release surface.

43. The locking counter-connector according to claim 38, further comprising:
a first counter-connector-sided anti-rotation structure arranged at the lateral receptacle surface and being rotational symmetric of order two with respect to the counter-connector axis,
wherein the first counter-connector-sided anti-rotation structure is configured for engagement with a first connector-sided anti-rotation structure of the locking connector by relatively displacing the locking counter-connector and locking-connector towards each other.

44. The locking counter-connector according to claim 43, wherein the first counter-connector-sided anti-rotation structure includes a plurality of anti-rotation protrusions, each extending from the lateral receptacle surface.

45. The locking counter-connector according to claim 44, wherein each of the plurality of anti-rotation protrusions are split into a first protrusion part and a second protrusion part, wherein the first protrusion part and the second protrusion part are each circumferentially aligned with each other and are axially spaced apart with respect to the counter-connector axis, and
wherein a portion of the locking member is axially arranged between the first protrusion parts and the second protrusion parts.

46. The locking counter-connector according to claim 34, further comprising a field device receiving receptacle that extends along the counter-connector axis and is open at the distal counter-connector end,
wherein the field device receiving receptacle and the stub-receiving receptacle merge into one other within the locking counter-connector.

47. A field device being an electric servo drive with a rotatory drive shaft, the rotatory drive shaft being an output member of the electric servo drive, the field device comprising the locking counter-connector according to claim 46,
wherein the rotatory drive shaft projects into the field device receiving receptacle from the distal counter-connector end and in alignment with the counter-connector axis.

48. A locking connector arrangement comprising a locking connector and a locking counter-connector,
wherein the locking connector comprises:
a connector stub having a stub body that extends along a connector axis between a proximal stub end and a distal stub end;
a through-going access channel that is coaxial with respect to the connector axis and extending through the stub body; and
a circumferential locking structure arranged at a lateral stub body surface,
wherein the locking counter-connector comprises:
a counter-connector body having a stub-receiving receptacle that extends along a counter-connector axis, the counter-connector axis extending between a proximal counter-connector end and a distal counter-connector end, the stub-receiving receptacle being open at the proximal counter-connector end; and
a locking member arranged to be movable to the counter-connector body between a locking position and a releasing position,
wherein the locking member is arranged to interfere with the locking connector to axially lock the locking connector and the locking counter-connector with respect to each other in the locking position, and not to interfere with the locking connector in the releasing position,
wherein the locking connector and the locking counter-connector are releasably coupleable, and
wherein in a coupled configuration the connector axis is aligned with the counter-connector axis and the stub body is at least partly received within the stub-receiving receptacle.

49. The locking connector arrangement according to claim 48, wherein the circumferential locking structure and the locking member interact in a in a plurality of engagement zones in the locking position, and
wherein the plurality of engagement zones are circumferentially spaced apart with respect to each other.

50. An connector for releasably coupling a field device with an inner room of a fluidic component via a counter-connector and/or the field device, the connector comprising:
a connector stub having a stub body that extends along a connector axis between a proximal stub end and a distal stub end of the stub body;
an access channel that is coaxial with respect to the connector axis and extend through the stub body;
an anti-rotation structure arranged at a lateral stub body surface, the anti-rotation structure being rotationally symmetric of order two with respect to the connector axis; and
a circumferential locking structure arranged at the lateral stub body surface,
wherein the anti-rotation structure of the connector is configured for engagement with the anti-rotation structure of the counter-connector by relatively displacing the connector and the counter-connector towards each other, and
wherein the circumferential locking structure of the connector and a locking member of the counter-connector are configured to axially lock the connector and the counter-connector with respect to each other.
